(19) United States
(12) Patent Application Publication
(10) Pub. No.: US 2026/0106647 A1
(43) Pub. Date: Apr. 16, 2026

(54) SCALABLE DESIGN OF RECONFIGURABLE INTELLIGENT SURFACES

(71) Applicant: QUALCOMM Incorporated, San Diego, CA (US)

(72) Inventors: Narayan PRASAD, Westfield, NJ (US); Karoly BECZE, Escondido, CA (US); Lida AKHOONDZADEHASL, Sunnyvale, CA (US); Kobi RAVID, Closter, NJ (US); Allen Minh-Triet TRAN, Rancho Santa Fe, CA (US); Tao LUO, San Diego, CA (US)

(21) Appl. No.: 18/916,538

(22) Filed: Oct. 15, 2024

(51) Int. Cl. H04B 7/04; H04L 5/00

(52) U.S. Cl. CPC H04B 7/04013; H04L 5/0053

(57) ABSTRACT

Methods, systems, and devices for wireless communications are described. A forwarding device (e.g., a reconfigurable intelligent surface (RIS)) may transmit a capability message indicating one or more timing parameters associated with a time duration for the forwarding device to switch a set of forwarding elements from forwarding in a first direction to forwarding in a second direction. The forwarding device may receive, based on the indicated one or more timing parameters, one or more control messages that instructs the forwarding device to forward signal energy in the first direction during a first symbol period and to forward signal energy in the second direction during a second symbol period. The first symbol period may be different from the second symbol period. The forwarding device may include a primary array including a first set of forwarding elements and a secondary array including a second set of forwarding elements.

### FIELD OF TECHNOLOGY

The present disclosure relates to wireless communications, including scalable design of reconfigurable intelligent surfaces.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a forwarding device is described. The method may include transmitting a capability message indicating one or more timing parameters associated with a time duration for the forwarding device to switch a set of multiple forwarding elements from forwarding in a first direction to forwarding in a second direction and receiving, based on the indicated one or more timing parameters, one or more control messages that instructs the forwarding device to forward signal energy in the first direction during a first symbol period and to forward signal energy in the second direction during a second symbol period, where the first symbol period is different from the second symbol period.

A forwarding device for wireless communications is described. The forwarding device may include one or more memories storing processor executable code, and one or more processors coupled with the one or more memories. The one or more processors may individually or collectively be operable to execute the code to cause the forwarding device to transmit a capability message indicating one or more timing parameters associated with a time duration for the forwarding device to switch a set of multiple forwarding elements from forwarding in a first direction to forwarding in a second direction and receive, based on the indicated one or more timing parameters, one or more control messages that instructs the forwarding device to forward signal energy in the first direction during a first symbol period and to forward signal energy in the second direction during a second symbol period, where the first symbol period is different from the second symbol period.

Another forwarding device for wireless communications is described. The forwarding device may include means for transmitting a capability message indicating one or more timing parameters associated with a time duration for the forwarding device to switch a set of multiple forwarding elements from forwarding in a first direction to forwarding in a second direction and means for receiving, based on the indicated one or more timing parameters, one or more control messages that instructs the forwarding device to forward signal energy in the first direction during a first symbol period and to forward signal energy in the second direction during a second symbol period, where the first symbol period is different from the second symbol period.

A non-transitory computer-readable medium storing code for wireless communications is described. The code may include instructions executable by one or more processors to transmit a capability message indicating one or more timing parameters associated with a time duration for the forwarding device to switch a set of multiple forwarding elements from forwarding in a first direction to forwarding in a second direction and receive, based on the indicated one or more timing parameters, one or more control messages that instructs the forwarding device to forward signal energy in the first direction during a first symbol period and to forward signal energy in the second direction during a second symbol period, where the first symbol period is different from the second symbol period.

Some examples of the method, forwarding devices, and non-transitory computer-readable medium described herein may further include operations, features, means, or instructions for transmitting an operating state message indicating a current operating state of an array including the set of multiple forwarding elements of the forwarding device, where the current operating state may be one of a set of multiple operating states, and where the one or more control messages may be based on the current operating state.

In some examples of the method, forwarding devices, and non-transitory computer-readable medium described herein, the one or more timing parameters includes a first timing parameter that indicates a quantity of slots, a quantity of symbols, or a time duration for the forwarding device to switch the set of multiple forwarding elements of the array from forwarding in the first direction to forwarding in the second direction while the array may be in the current operating state and the quantity of slots or the quantity of symbols may be based on a sub-carrier spacing.

In some examples of the method, forwarding devices, and non-transitory computer-readable medium described herein, each of the one or more timing parameters may be associated with a respective operating state of a set of multiple operating states.

In some examples of the method, forwarding devices, and non-transitory computer-readable medium described herein, the one or more timing parameters includes a first timing parameter that indicates a quantity of slots, a quantity of symbols, or a time duration for the forwarding device to switch the set of multiple forwarding elements from forwarding in the first direction to forwarding in the second direction.

In some examples of the method, forwarding devices, and non-transitory computer-readable medium described herein, receiving the one or more control messages may include operations, features, means, or instructions for receiving, based on the indicated one or more timing parameters, an indication of a set of distinct voltages that may be each associated with a forwarding direction.

In some examples of the method, forwarding devices, and non-transitory computer-readable medium described herein, receiving the one or more control messages may include operations, features, means, or instructions for receiving the one or more control messages, indicating to forward signal energy in the first direction during the first symbol period using a first subset of electronic components and indicating to forward signal energy in the second direction during the second symbol period using a second subset of electronic components.

In some examples of the method, forwarding devices, and non-transitory computer-readable medium described herein, the first subset of electronic components may be associated with a first capacitor bank and the second subset of electronic components may be associated with a second capacitor bank.

In some examples of the method, forwarding devices, and non-transitory computer-readable medium described herein, receiving the one or more control messages may include operations, features, means, or instructions for receiving the one or more control messages, forwarding, using a first subset of electronic components, signal energy in the first direction during the first symbol period indicated in the one or more control messages, and forwarding, using a second subset of electronic components, signal energy in the second direction during the second symbol period indicated in the control message.

In some examples of the method, forwarding devices, and non-transitory computer-readable medium described herein, an array including the set of multiple forwarding elements includes a first set of multiple forwarding elements and a second set of multiple forwarding elements and the first set of multiple forwarding elements may be a primary array and the second set of multiple forwarding elements may be a secondary array.

In some examples of the method, forwarding devices, and non-transitory computer-readable medium described herein, the second set of multiple forwarding elements of the secondary array may be associated with a first voltage source based on the first set of multiple forwarding elements of the primary array being associated with the first voltage source.

Some examples of the method, forwarding devices, and non-transitory computer-readable medium described herein may further include operations, features, means, or instructions for switching one or more secondary varactor diodes associated with the second set of multiple forwarding elements from a first reverse bias to a second reverse bias based on a reverse bias of one or more primary varactor diodes associated with the first set of multiple forwarding elements, where the first reverse bias uses a voltage that causes forwarding elements to absorb a larger fraction of incident signal energy than the second reverse bias.

Some examples of the method, forwarding devices, and non-transitory computer-readable medium described herein may further include operations, features, means, or instructions for switching one or more secondary varactor diodes associated with the second set of multiple forwarding elements from a first reverse bias based on a reverse bias of one or more primary varactor diodes associated with the first set of multiple forwarding elements to a second reverse bias, where the second reverse bias uses a voltage that causes forwarding elements to absorb a larger fraction of incident signal energy than the first reverse bias.

In some examples of the method, forwarding devices, and non-transitory computer-readable medium described herein, the forwarding device includes a reflecting device, a refracting device, or both.

In some examples of the method, forwarding devices, and non-transitory computer-readable medium described herein, the set of multiple forwarding elements includes a set of multiple varactor diodes.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports scalable design of reconfigurable intelligent surfaces in accordance with one or more aspects of the present disclosure.

FIG. 2 shows an example of a wireless communications system that supports scalable design of reconfigurable intelligent surfaces in accordance with one or more aspects of the present disclosure.

FIG. 3 shows an example of a forwarding element diagram that supports scalable design of reconfigurable intelligent surfaces in accordance with one or more aspects of the present disclosure.

FIG. 4 shows an example of a timing diagram that supports scalable design of reconfigurable intelligent surfaces in accordance with one or more aspects of the present disclosure.

FIG. 5 shows an example of a capacitor bank that supports scalable design of reconfigurable intelligent surfaces in accordance with one or more aspects of the present disclosure.

FIG. 6 shows an example of an array diagram that supports scalable design of reconfigurable intelligent surfaces in accordance with one or more aspects of the present disclosure.

FIG. 7 shows an example of a process flow that supports scalable design of reconfigurable intelligent surfaces in accordance with one or more aspects of the present disclosure.

FIGS. 8 and 9 show block diagrams of devices that support scalable design of reconfigurable intelligent surfaces in accordance with one or more aspects of the present disclosure.

FIG. 10 shows a block diagram of a communications manager that supports scalable design of reconfigurable intelligent surfaces in accordance with one or more aspects of the present disclosure.

FIG. 11 shows a diagram of a system including a device that supports scalable design of reconfigurable intelligent surfaces in accordance with one or more aspects of the present disclosure.

FIGS. 12 through 14 show flowcharts illustrating methods that support scalable design of reconfigurable intelligent surfaces in accordance with one or more aspects of the present disclosure.

### DETAILED DESCRIPTION

Some wireless communications systems may employ one or more reflecting devices such as a reconfigurable intelligent surface (RIS) to cover blind spots and coverage holes by programming tunable components to reflect a signal around a direct-path blockage (e.g., a large building). Typical RIS unit-cell tunable components (e.g., elements) may be based on p-type, intrinsic, n-type (PIN) diodes, varactor diodes, or radio frequency (RF) switches. However, link budgets may dictate a large RIS array size, resulting in power consumption issues, cost issues, or both. Specifically, a PIN diode-based RIS may consume significant power across the surface of the RIS array while the PIN diodes are in an ON state. Alternatively, for an RF switch-based RIS, cost may be a bottleneck for scalability. In some examples, varactor diode-based RIS may be a promising alternative to PIN diode-based RIS and RF switch-based RIS, if a power efficient control drive is enabled at high frequencies (e.g., mmWave). Specifically, a varactor diode-based RIS may be composed of a quantity of control lines that provide one of 8 distinct voltages (e.g., an 8-ary alphabet) to reverse-bias varactor diodes to one of 8 different states. For example, a first control line may provide a first voltage value that reverse-biases 32 RIS elements associated with the first control line. Similarly, a second control line may provide a second voltage value that reverse-biases 32 RIS elements associated with the second control line. Changing the first voltage value or second voltage value may cause the RIS to reflect incoming signals in a second direction instead of a first direction, where the second direction may be different from the first direction. In some cases, the first control line may switch from a first voltage to a second voltage, although the varactor diodes may take time to settle at the second voltage (e.g., may be associated with a transition time). Similarly, the switching of a control line from a first voltage to a second voltage may be associated with a different transition time. A RIS design that increases the power efficiency of a varactor-based RIS (e.g., at high frequencies and at large array sizes) may be desired.

In some implementations, a forwarding device (e.g., a RIS) may transmit, to a network node, a capability message indicating one or more capabilities of the forwarding device, including at least timing information associated with a transition time in one or more operating states. For example, the capability message may include the duration (e.g., time duration) for the forwarding device to switch one or more control lines from a first set of voltages for reflecting signal energy in a first direction to a second set of voltages for reflecting signal energy in a second direction while in a first operating state. Based on the capability message, the network node may transmit, to the forwarding device, control signaling that instructs the forwarding device to reflect a first signal in a first direction during a first symbol and to reflect a second signal in a second direction during a second symbol. In some examples, the control signaling may dynamically instruct the forwarding device to use an M-ary alphabet (e.g., to use 8 distinct voltages for an 8-ary alphabet, or to use 4 distinct voltages for a 4-ary alphabet). In some examples, the control signaling may instruct the forwarding device to use a first set of elements (e.g., a first circuit of varactor diodes) to reflect the first signal and a second set of elements to reflect the second signal. In other examples, the forwarding device may autonomously use a first set of elements (e.g., a first circuit of varactor diodes) to reflect the first signal and a second set of elements to reflect the second signal. In either case, using a first set of elements to reflect the first signal and a second set of elements to reflect the second signal may enable the first signal and the second signal to be reflected in different directions in a shorter amount of time than otherwise possible using a common set of elements, based on the transition time of the elements or control lines. In some examples, the surface of the forwarding device may be divided into a main portion and an extension portion, where one or more elements on the extension portion of the forwarding device may be controlled based on one or more control lines used for controlling one or more elements of the main portion.

Particular aspects of the subject matter described herein may be implemented to realize one or more potential advantages. The described techniques may provide for improved communication reliability, reduced power consumption, more efficient utilization of communication resources, improved coordination between devices, longer battery life, and improved utilization of processing capability. For example, a wireless communications system may scale up a forwarding device (e.g., a RIS) with a larger array size or aperture size with minimal control complexity costs by employing at least two separate alternating circuit sets at the forwarding device. Based on timing information and operating state information provided by the forwarding device, the network node may instruct the forwarding device to forward signal energy in a first direction (e.g., to a first user equipment (UE)) using a first circuit set during a first symbol. The forwarding device may prepare a second circuit set during the first symbol. The network node may instruct the forwarding device to forward signal energy in a second direction (e.g., to a second UE) using the second, pre-prepared circuit set during the second symbol. In this way, the forwarding device may reduce a slew rate requirement on one or more operational amplifiers (op-amps) in the circuit sets. Alternatively, the forwarding device can itself use an implementation based on two circuit sets, to forward signal energy in a first direction using a first circuit set during a first symbol period, and forward signal energy in a second direction using a second circuit set during a second symbol period to reduce the slew rate requirement, without such indication from the networking node. Additionally, or alternatively, the forwarding device may include a primary array and a secondary array, where a voltage for one or more forwarding elements on the secondary array may be based on a voltage for one or more forwarding elements on the primary array. In this way, the forwarding device may increase the quantity of forwarding elements used to forward signal energy without incurring a large control complexity cost.

Aspects of the disclosure are initially described in the context of wireless communications systems. Aspects of the disclosure are then described in the context of a forwarding element diagram, a timing diagram, a capacitor bank diagram, an array diagram, and a process flow. Aspects of the disclosure are further illustrated by and described with reference to apparatus diagrams, system diagrams, and flowcharts that relate to scalable design of reconfigurable intelligent surfaces.

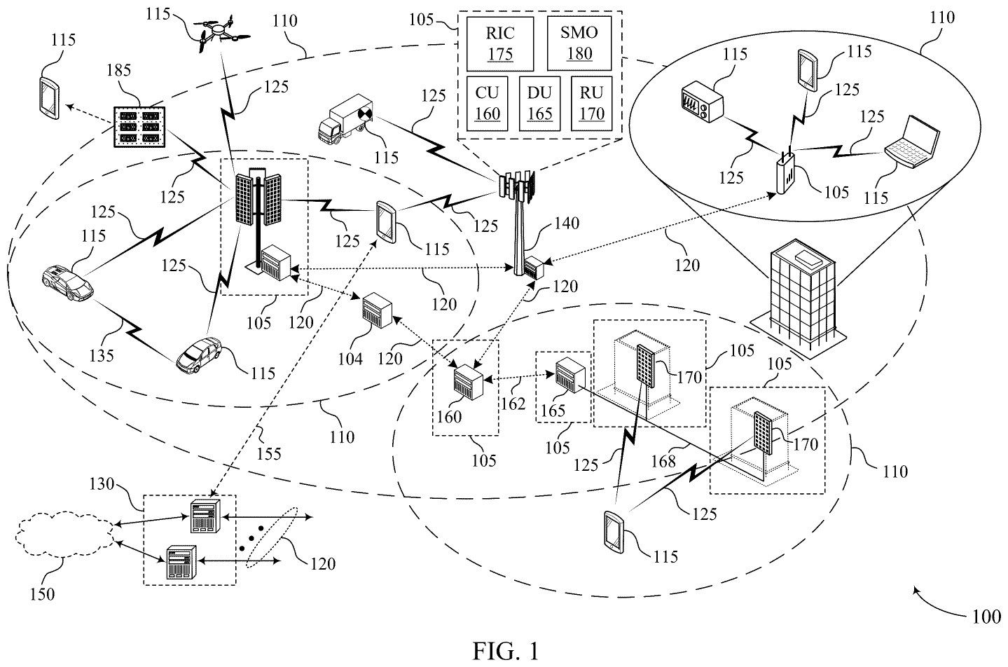

FIG. 1 shows an example of a wireless communications system 100 that supports scalable design of reconfigurable intelligent surfaces in accordance with one or more aspects of the present disclosure. The wireless communications system 100 may include one or more devices, such as one or more network devices (e.g., network nodes 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network nodes 105 may be dispersed throughout a geographic area to form the wireless communications system 100 and may include devices in different forms or having different capabilities. In various examples, a network node 105 may be referred to as a network element, a mobility element, a radio access network (RAN) node, or network equipment, among other nomenclature. In some examples, network nodes 105 and UEs 115 may wirelessly communicate via communication link(s) 125 (e.g., a radio frequency (RF) access link). For example, a network node 105 may support a coverage area 110 (e.g., a geographic coverage area) over which the UEs 115 and the network node 105 may establish the communication link(s) 125. The coverage area 110 may be an example of a geographic area over which a network node 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network nodes 105), as shown in FIG. 1.

As described herein, a node of the wireless communications system 100, which may be referred to as a network node, or a wireless node, may be a network node 105 (e.g., any network node described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network node 105. As another example, a first node may be configured to communicate with a second node or a third node. In one aspect of this example, the first node may be a UE 115, the second node may be a network node 105, and the third node may be a UE 115. In another aspect of this example, the first node may be a UE 115, the second node may be a network node 105, and the third node may be a network node 105. In yet other aspects of this example, the first, second, and third nodes may be different relative to these examples. Similarly, reference to a UE 115, network node 105, apparatus, device, computing system, or the like may include disclosure of the UE 115, network node 105, apparatus, device, computing system, or the like being a node. For example, disclosure that a UE 115 is configured to receive information from a network node 105 also discloses that a first node is configured to receive information from a second node.

In some examples, network nodes 105 may communicate with a core network 130, or with one another, or both. For example, network nodes 105 may communicate with the core network 130 via backhaul communication link(s) 120 (e.g., in accordance with an S1, N2, N3, or other interface protocol). In some examples, network nodes 105 may communicate with one another via backhaul communication link(s) 120 (e.g., in accordance with an X2, Xn, or other interface protocol) either directly (e.g., directly between network nodes 105) or indirectly (e.g., via the core network 130). In some examples, network nodes 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network nodes 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network node 105 (e.g., a base station 140) may be implemented in an aggregated (e.g., monolithic, standalone) base station architecture, which may be configured to utilize a protocol stack that is physically or logically integrated within one network node (e.g., a network node 105 or a single RAN node, such as a base station 140).

In some examples, a network node 105 may be implemented in a disaggregated architecture (e.g., a disaggregated base station architecture, a disaggregated RAN architecture), which may be configured to utilize a protocol stack that is physically or logically distributed among multiple network nodes (e.g., network nodes 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network node 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network nodes 105 in a disaggregated RAN architecture may be co-located, or one or more components of the network nodes 105 may be located in distributed locations (e.g., separate physical locations). In some examples, one or more of the network nodes 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network nodes (e.g., one or more of the network nodes 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network nodes 105 (e.g., network nodes 105 or IAB node(s) 104) may be partially controlled by each other. The IAB node(s) 104 may be referred to as a donor entity or an IAB donor. A DU 165 or an RU 170 may be partially controlled by a CU 160 associated with a network node 105 or base station 140 (such as a donor network node or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support scalable design of reconfigurable intelligent surfaces as described herein. For example, some operations described as being performed by a UE 115 or a network node 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network nodes 105 and the network equipment including macro eNBs or gNBs, small cell eNBs or gNBs, or relay base stations, among other examples, as shown in FIG. 1.

The UEs 115 and the network nodes 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network node 105 and other devices may refer to communication between the devices and any portion (e.g., entity, sub-entity) of a network node 105. For example, the terms “transmitting,” “receiving,” or “communicating,” when referring to a network node 105, may refer to any portion of a network node 105 (e.g., a base station 140, a CU 160, a DU 165, a RU 170) of a RAN communicating with another device (e.g., directly or via one or more other network nodes, such as one or more of the network nodes 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network nodes 105 or the UEs 115 may be expressed in multiples of a basic time unit which may, for example, refer to a sampling period of TS=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network node 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network node (e.g., a network node 105). In some other examples, overlapping coverage areas, such as a coverage area 110, associated with different technologies may be supported by different network nodes (e.g., the network nodes 105). The wireless communications system 100 may include, for example, a heterogeneous network in which different types of the network nodes 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network node 105 (e.g., a base station 140, an RU 170), which may support aspects of such D2D communications being configured by (e.g., scheduled by) the network node 105. In some examples, one or more UEs 115 of such a group may be outside the coverage area 110 of a network node 105 or may be otherwise unable to or not configured to receive transmissions from a network node 105. In some examples, groups of the UEs 115 communicating via D2D communications may support a one-to-many (1:M) system in which each UE 115 transmits to one or more of the UEs 115 in the group. In some examples, a network node 105 may facilitate the scheduling of resources for D2D communications. In some other examples, D2D communications may be carried out between the UEs 115 without an involvement of a network node 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network nodes 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW or mmWave) communications between the UEs 115 and the network nodes 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network nodes 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network node 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network node 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network node 105 may be located at diverse geographic locations. A network node 105 may include an antenna array with a set of rows and columns of antenna ports that the network node 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network node 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may employ one or more reflecting devices such as a RIS 185 to cover blind spots and coverage holes by programming tunable components to reflect a signal around a direct-path blockage (e.g., a large building). For example, a network node 105 may communicate with the RIS 185 via a control link 125, and may transmit signal energy towards the RIS 185 for the RIS 185 to forward to a UE 115. The RIS 185 may include a reflecting device, a refracting device, a forwarding device, or a combination thereof. Typical RIS 185 unit-cell tunable components (e.g., elements) may be based on p-type, intrinsic, n-type (PIN) diodes, varactor diodes, or radio frequency (RF) switches. However, link budgets may dictate a large RIS 185 array size, resulting in power consumption issues, cost issues, or both. Specifically, a PIN diode-based RIS 185 may consume significant power across the surface of the RIS 185 array while the PIN diodes are in an ON state. Alternatively, for an RF switch-based RIS 185, cost may be a bottleneck for scalability. In some examples, varactor diode-based RIS 185 may be a promising alternative to PIN diode-based RIS 185 and RF switch-based RIS 185, if a power efficient control drive is enabled at high frequencies (e.g., mmWave). Specifically, a varactor diode-based RIS 185 may be composed of a quantity of control lines that provide one of 8 distinct voltages (e.g., an 8-ary alphabet) to reverse-bias varactor diodes to one of 8 different states. For example, a first control line may provide a first voltage value that reverse-biases one or more (e.g., 32) RIS 185 elements associated with the first control line. Similarly, a second control line may provide a second voltage value that reverse-biases one or more (e.g., 32) RIS 185 elements associated with the second control line. Changing the first voltage value or second voltage value may cause the RIS 185 to reflect incoming signals in a second direction instead of a first direction, where the second direction may be different from the first direction. In some cases, the first control line may switch from a first voltage to a second voltage, although the varactor diodes may take time to settle at the second voltage (e.g., may be associated with a transition time). Similarly, the switching of a control line from a first voltage to a second voltage may be associated with a different transition time. A RIS 185 design that increases the power efficiency of a varactor-based RIS 185 (e.g., at high frequencies and at large array sizes) may be desired.

In some implementations, a forwarding device (e.g., the RIS 185) may transmit, to a network node 105, a capability message indicating one or more capabilities of the RIS 185, including at least timing information associated with a transition time in one or more operating states. For example, the capability message may include the time duration for the RIS 185 to switch one or more control lines from a first set of voltages reflecting in a first direction to a second set of voltages reflecting in a second direction while in a first operating state. Based on the capability message, the network node may transmit, to the RIS 185, control signaling that instructs the RIS 185 to reflect a first signal in a first direction during a first symbol and to reflect a second signal in a second direction during a second symbol. In some examples, the control signaling may dynamically instruct the RIS 185 to use an M-ary alphabet (e.g., to use 8 distinct voltages for an 8-ary alphabet, or to use 4 distinct voltages for a 4-ary alphabet). In some examples, the control signaling may instruct the RIS 185 to use a first set of elements (e.g., a first circuit of varactor diodes) to reflect the first signal and a second set of elements to reflect the second signal, such that the first signal and the second signal may be reflected in different directions. In other examples, the forwarding device may autonomously use a first set of elements (e.g., a first circuit of varactor diodes) to reflect the first signal and a second set of elements to reflect the second signal. In either case, using a first set of elements to reflect the first signal and a second set of elements to reflect the second signal may enable the first signal and the second signal to be reflected in different directions in a shorter amount of time than otherwise possible using a common set of elements, based on the transition time of the elements or control lines. In some examples, the surface of the RIS 185 may be divided into a main portion and an extension portion, where one or more elements on the extension portion of the RIS 185 may be based on one or more control lines of the main portion.

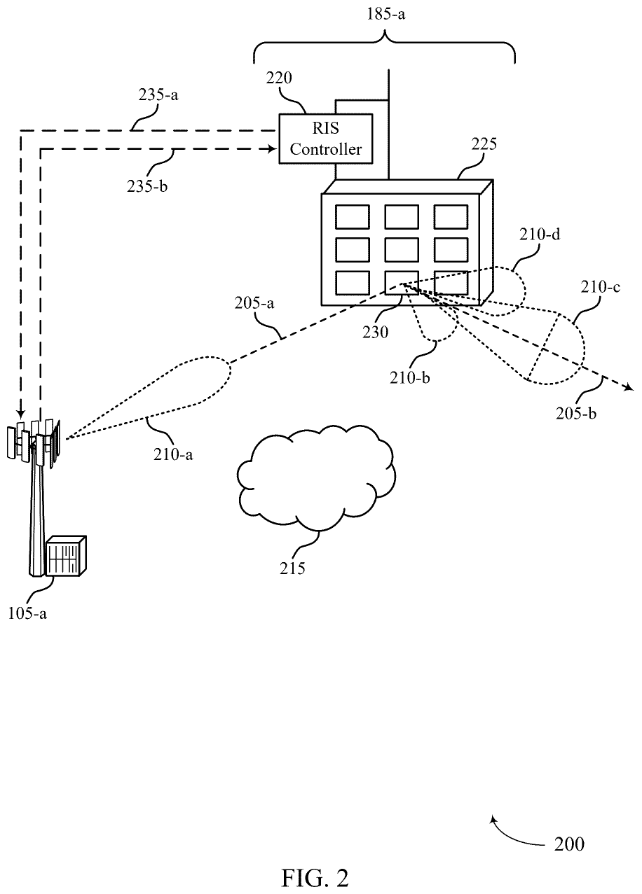

FIG. 2 shows an example of a wireless communications system 200 that supports scalable design of reconfigurable intelligent surfaces in accordance with one or more aspects of the present disclosure. In some examples, the wireless communications system 200 may implement aspects of the wireless communications system 100. For example, the wireless communications system 200 includes a network node 105-a and a RIS 185-a, which may be examples of corresponding devices described with reference to FIG. 1. Additionally, or alternatively, the network node 105-a and the RIS 185-a may be an example of other types of wireless devices, such as an IAB node or another type of transmitter, receiver, forwarding device, reflecting device, or refracting device. Thus, although aspects of the present disclosure are described with reference to a network node 105 and a RIS 185, it is understood that the described techniques may be performed by a wireless device different from a network node 105 and a RIS 185. As described herein, operations performed by the network node 105-a and the RIS 185-a may be respectively performed by a UE 115, a network node 105, or another wireless device, and the examples shown should not be construed as limiting.

Devices in the wireless communications system 200 may support the forwarding of signal energy 205 from the network node 105-a in one or more directions 210. For example, the network node 105-a may have a message to transmit via the signal energy 205 to a target wireless device (e.g., a UE 115 described with reference to FIG. 1). However, there may be a blockage 215 (e.g., a direct-path blockage or obstacle such as a large building) in the direct path between the network node 105-a and the target wireless device. Thus, the network node 105-a may employ the RIS 185-a to cover blind spots and coverage holes via programmable reflections. For example, the RIS 185-a may act as a programmable mirror with a reflecting surface that can be programmed to forward an incident signal (e.g., the signal energy 205-a) in one or more different directions 210. The RIS 185-a may include one or more distinct entities, including at least a RIS controller 220 (e.g., a RIS mobile termination (RIS-MT) array, a RIS control board) and a RIS array 225. The RIS array 225 may include one or more forwarding elements 230. The one or more forwarding elements 230 (e.g., RIS unit cells) may be connected to one or more tunable electronic components that enable anomalous reflections. For example, the one or more forwarding elements 230 may be PIN diode-based, varactor diode-based, RF switch-based, or a combination thereof. By adjusting the voltages to the one or more forwarding elements 230, the RIS 185-a may change or control the electromagnetic characteristics of the one or more forwarding elements 230 (e.g., electrical length). In this manner, the RIS 185-a may program the surface (e.g., the RIS array 225) to point, reflect, refract, or otherwise forward incident signal energy 205-a in a particular direction 210 or achieve another functionality in terms of how the reflected wavefront is shaped.

A link budget may dictate a size of the RIS array 225 to be relatively large. For example, if the network node 105-a has multiple signals (e.g., associated with multiple links) for the RIS 185-a to reflect at a given time, the RIS array 225 may use at least a threshold quantity of forwarding elements 230 per signal or link, and the total surface area (e.g., aperture size) of the RIS array 225 may be relatively large to accommodate the threshold quantity of forwarding elements 230. As a result, the power consumption cost at the RIS 185-a may be a scalability issue. Specifically, for a PIN diode-based RIS 185-a, a shift register-based control drive may be power efficient with a relatively lower component cost (e.g., a PIN diode may have a lower cost than a varactor diode). However, surface power (e.g., power consumed across the surface of the RIS array 225) may become an unavoidable bottleneck for scalability. For example, power consumed by one or more PIN diodes (e.g., the forwarding elements 230 on the surface of the RIS array 225, of which there may be thousands) in an ON-state may be significant (e.g., over 50 Watts (W) for a 64×64 1-bit dual polarized PIN diode RIS at 28 GHz). For an RF switch-based RIS 185-a, cost may be a bottleneck for scalability at mmWave frequencies. A varactor diode-based RIS 185-a may be a promising alternative if an associated control drive (e.g., associated with the RIS controller 220) can be made power efficient at mmWave frequencies. A power efficient control drive for a varactor diode-based RIS 185-a may be desirable for scaling up a RIS array 225 without prohibitive power consumption or cost issues.

An example varactor diode-based RIS 185-a may be a 3.2 GHz, 3-bit 16×8 device limited to two columns of control per group. For example, a first power associated with a field programmable gate array (FPGA) board may be about 5 W, a second power associated with a control drive may be 1715 mW, and a third power associated with the surface of the RIS array 225 may be almost zero W and negligible. The control power consumption may be the limiting factor or bottleneck for scalability, since 0.43 W may be added per new control line, which may be used to power each added forwarding element 230 or group. Therefore, such an example architecture may not be scalable to large array surface areas, especially at mmWave frequencies, due to at least two limitations. First, a fixed 8-ary alphabet (e.g., where each control line may provide one of eight distinct voltages to reverse bias one or more varactor diodes to one of eight different states as shown in Table 1, and where each group of 32 forwarding elements 230 may be driven by one control line) may be used for all RIS patterns, which sacrifices a key varactor advantage of continuous impedance tunability. Second, increasing the aperture (e.g., surface area) of the RIS array 225 in this example varactor diode-based RIS 185-a may entail significant increases in power consumption at the RIS controller 220. For example, in order to scale up this example RIS 185-a to a larger size of the RIS array 225, more control lines may be introduced, where each additional control line adds a substantial power cost.

TABLE 1
Eight coding states of a 3-bit RIS 185-a.

| State | Bias Voltage (V) |
|---|---|
| 0 | 0.0 |
| 1 | −3.0 |
| 2 | −4.0 |
| 3 | −4.6 |
| 4 | −5.3 |
| 5 | −6.0 |
| 6 | −8.0 |
| 7 | −20.0 |

Aspects of the present disclosure provide an architecture for a varactor-based RIS 185-a at mmWave frequencies (e.g., 28 GHz, or other relatively high frequencies) and multiple variants that are scalable to large RIS arrays 225. For example, some implementations may involve target anomalous reflection-dependent choice of an M-ary alphabet. This may result in improved performance from increased pattern design flexibility compared to other designs in which only a fixed M-ary alphabet is allowed for all RIS patterns (e.g., 1.5 to 2.0 decibel (dB) performance improvement). Additionally, or alternatively, some implementations may provide a power efficient design of a control drive of the RIS 185-a, resulting in order-of-magnitude power savings (e.g., by a factor of 40). Corresponding timing-related RIS capability parameters are proposed. Additionally, or alternatively, some implementations may involve a boundary extension design. For example, extensions may be added to increase the aperture area of the RIS array 225 (e.g., a reflector array) while limiting incremental circuit complexity (e.g., up to 4 dB performance improvement).

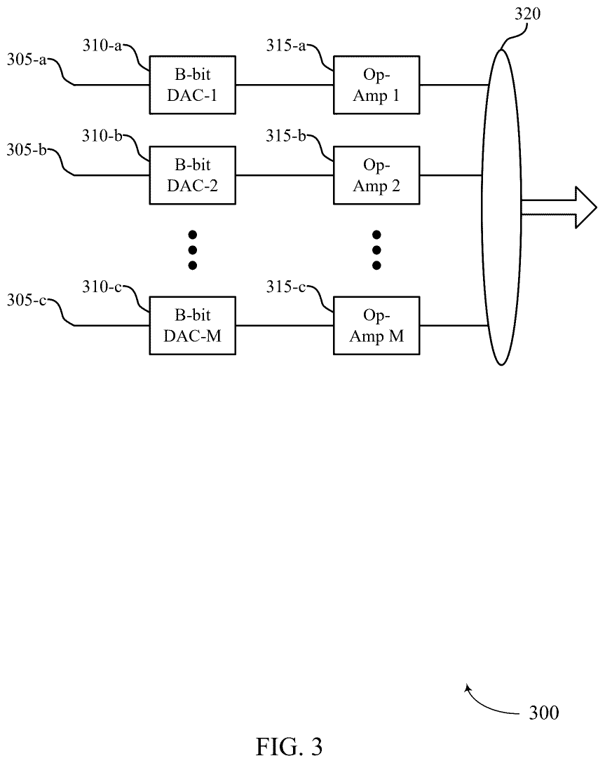

Some implementations of the varactor-based RIS 185-a architecture include efficient (e.g., flexible) alphabet selection. For example, as illustrated in and described with reference to FIG. 3, the RIS 185-a may include a quantity M of power rails that together provide a certain set of direct current (DC) voltages associated with a direction 210 in which the RIS 185-a may forward incident signal energy 205-a. Each power rail may include at least one digital-to-analog converter (DAC) output (e.g., with B bits) amplified by an op-amp. A RIS 185-a configured with an M-ary alphabet may include M power rails, with M respective B-bit DAC outputs (e.g., M=8 and B=8). A varactor may be a diode that can be tuned by applying a biasing voltage that changes a capacitance of the varactor and influences the electromagnetic characteristics of an associated forwarding element 230 (e.g., a reflecting element). By changing the voltages applied across the varactor diodes of the RIS array 225, the RIS 185-a may reflect the incident signal energy 205-a in a particular direction 210 or reflect the wavefront in a particular way. That is, the target direction 210 or wavefront for the reflected signal energy 205-b may be translated or mapped to a set of input voltages to be applied on the varactor diodes associated with the forwarding elements 230 on the RIS array 225. For example, each of the N forwarding elements 230 (e.g., N varactor diodes across both polarizations) may be reverse biased by selecting (e.g., independently assigned to) one of M voltages associated with a respective power rail output via a multiplexer (MUX) (e.g., with a total of N MUXes). In some examples, additional (e.g., up to N) op-amps may be used, especially when individual forwarding elements (e.g., varactors) are connected via cables.

Limiting the set of voltages to a relatively small and fixed alphabet may limit the directions 210 or kinds of reflected wavefront shaping that are possible. In some implementations, the RIS 185-a or the network node 105-a may select a set of voltages (e.g., an M-ary alphabet) based on current operating conditions. For example, the network node 105-a may transmit, to the RIS 185-a, one or more control messages indicating the value of M, or indicating the set of distinct voltages that are each associated with a forwarding direction 210 (e.g., the set of voltages shown in Table 1). The network node 105-a, the RIS 185-a, or both may change the set of biasing voltages depending on the kind of reflection to be achieved. For example, by giving a different digital input to a DAC, a different analog value may be output, which may be amplified by an op-amp and (if selected from the M power rails by the MUX) may be used to reverse bias one or more varactor diodes to change a reflected signal characteristic (such as its direction 210 or energy or phase). Each forwarding element 230 may be switched to select from one of the M power rails. The set of M power rails (e.g., M reverse biasing voltages) may be changed dynamically by changing the DAC inputs, which may be done by the RIS 185-a in real time, e.g., in response to control signaling from the network node 105-a.

The RIS 185-a may ensure that the voltages are applied in such a way that the settling time (e.g., including the time for a forwarding element 230 to change from a first voltage to a second voltage) does not exceed a threshold time (e.g., a threshold settling time such as 200 nanoseconds (ns)). For example, the network node 105-a may change a reflection target with a time granularity of, e.g., one OFDM symbol duration. That is, the incident direction 210-a of the incident signal energy 205-a may be fixed, but the network node 105-a may switch from serving a first user (e.g., a first UE 115) at a first location associated with the direction 210-d to serving a second user (e.g., a second UE 115) at a second location associated with the direction 210-c. In order to do that, the RIS 185-a may quickly change the voltages applied to one or more forwarding elements 230 so that the settling time or transition time may be within the cyclic prefix of the symbol.

For different RIS codewords (e.g., patterns), the DAC states (and hence the power rail-amplified voltage values) can also be different. This implies that different RIS patterns can use different M-ary alphabets without increasing the quantity of control lines. In some examples, a pattern-dependent M-ary alphabet can provide noticeably improved performance over a fixed M-ary alphabet (e.g., for M=8, 1.5 to 2.0 dB gains may be achieved). In some examples, a forwarding element 230 may not immediately switch from a first voltage associated with a first power rail to a second voltage associated with a second power rail. Rather, a settling time may be associated with the transition from the first voltage to the second voltage. In some examples, a settling time of 200 nanosecond (ns) may be achieved, such that a change of DAC inputs is applied as corresponding power rail voltage outputs within 200 ns. A settling time being within a cyclic prefix duration implies that a switch of a RIS pattern every OFDM symbol with a duration of 8.9 microseconds (s) can be exploited. This is made possible by choosing an appropriate slew rate of op-amps (e.g., a slew rate to span 18 volts (V) to cover 20 femtofarads (fF) to 70 fF varactor capacitance range in 200 ns). Relating to power consumption, a high slew rate (e.g., a low settling time) requirement may be directly imposed as an op-amp requirement, but such an op-amp may have a higher quiescent current, which increases the driver power consumption (e.g., 3.6 milliamps (mA)*22 V per op-amp).

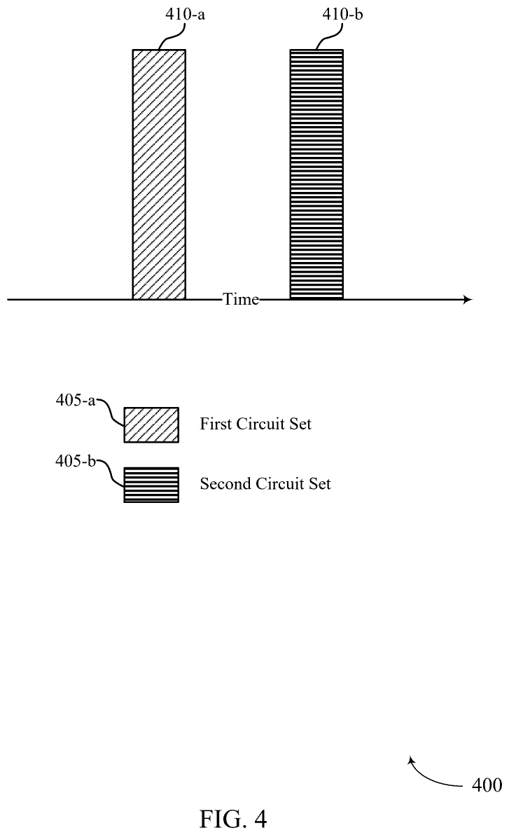

In some implementations (e.g., as described in more detail with reference to FIG. 4), a power-efficient varactor-based RIS 185-a may achieve a threshold settling time via pre-fetching and circuit-set switching. For example, the RIS 185-a may implement two or more sets of circuits for applying a RIS pattern. A circuit (e.g., a set of circuits) may include a subset of electronic components (e.g., a subset of the forwarding elements 230, a subset of DACs, a subset of op-amps, a subset of voltage sources, a subset of capacitors, a subset of other electronic components, or a combination thereof). Each circuit or set of circuits may be designed for a target OFDM symbol duration,

$${T}_{Sym}^{Tar} .$$

At least a first circuit set may be used to apply a current RIS pattern in a current OFDM symbol while at least a second circuit set may be used to prepare an updated RIS pattern to be used in a following symbol (e.g., a next symbol or another symbol in the future) where RIS pattern update is configured (e.g., required, signaled). In some examples, the first circuit set and the second circuit set may both feed to the same set of varactor diodes and forwarding elements 230. Each circuit set may realize separate biasing voltage sources and include distinct op-amps, tank capacitors, and other electronic components. In some examples, the network node 105-a may transmit, to the RIS 185-a, one or more control messages indicating that the RIS 185-a is to use circuit set switching. Based on circuit set switching being enabled by the one or more control messages or based on its autonomous implementation, the RIS controller 220 may realize a first reflection (e.g., a first forwarding) using a first circuit set while a second circuit set is preparing source voltages for a second reflection, and the RIS controller 220 may realize the second reflection (e.g., a second forwarding) using the second circuit set. Two or more circuit sets working in tandem may realize the varactor-based RIS 185-a.

For example, the RIS 185-a (e.g., the RIS controller 220) may transmit, to the network node 105-a and via a control link 235-a, a capability message indicating timing information (e.g., one or more timing parameters) associated with a time duration for the RIS 185-a to switch a circuit set of forwarding elements 230 from forwarding in a first direction 210-b to forwarding in a second direction 210-c. Based on the timing information, the network node 105-a may transmit, to the RIS controller 220 via the control link 235-b, one or more control messages indicating a RIS pattern to be used one or more symbols in advance. For example, the one or more control messages may instruct the RIS 185-a to forward signal energy in the direction 210-b during a first symbol period and to forward signal energy in the direction 210-c during a second symbol period. During the first symbol period, while a first circuit set is forwarding signal energy 205-a in the direction 210-b, a second circuit set (a circuit set unused for forwarding signal energy 205) may be preparing the indicated RIS pattern for the second symbol. That is, the RIS 185-a may prepare an indicated RIS pattern within one symbol interval, using a circuit set that is not being used for applying the pattern in the current symbol. Then, the RIS 185-a may switch to using the second circuit set with the prepared RIS pattern at the start of the second symbol (e.g., the symbol indicated by the one or more control messages). During the second symbol (e.g., while the second circuit set is forwarding the incoming signal energy 205-a from the incoming direction 210-a in the direction 210-b as reflected signal energy 205-b), the first circuit set may prepare the next updated RIS pattern. The two or more circuit sets may alternate between preparing a RIS pattern and forwarding signal energy 205 according to the prepared RIS pattern to drastically reduce a slew rate requirement on one or more op-amps by a large factor (e.g., a factor of 40 for an 8.9 μs settling time instead of a 200 ns settling time). The cost trade-off for such circuit set switching is that an additional circuit set may be implemented.

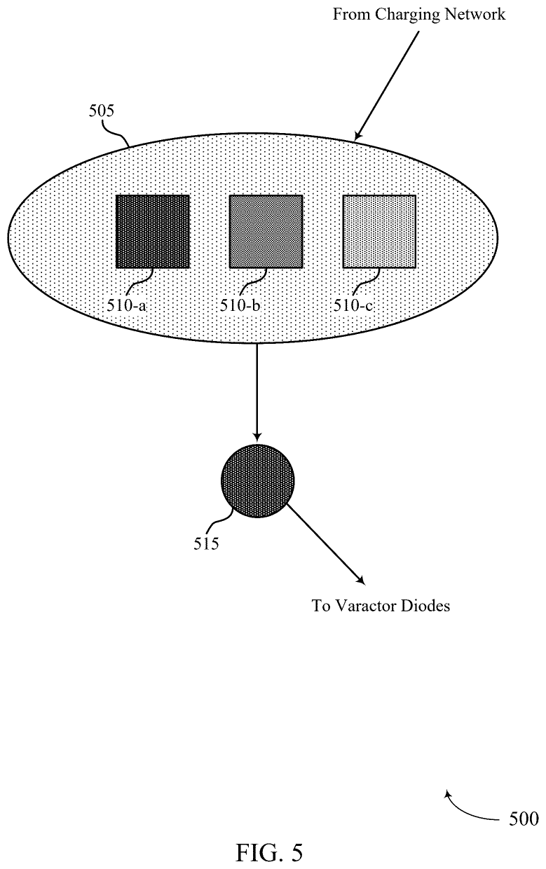

In some implementations, the varactor-based RIS 185-a may employ a bank of capacitors for power-efficiency, as illustrated and described in more detail with reference to FIG. 5. For example, the forwarding elements 230 (e.g., varactor diodes) may use a reverse biasing voltage as high in magnitude as 18 V (e.g., or a different, higher voltage). A baseline proposed approach may rely on an op-amp to raise each DAC output voltage to the target 18 V. However, in some implementations, the RIS 185-a may use a bank of charged tank capacitors holding a set of voltages. For a RIS pattern update (e.g., the one or more control messages), the RIS 185-a may switch each forwarding element 230 (e.g., each varactor diode) to the tank capacitor with the correct reverse biasing voltage. Each varactor diode (e.g., forwarding element 230) may discharge its connected biasing capacitor at a relatively slow rate. The slower-rate charging network may be enough to keep the capacitors charged and hold the target voltages. The RIS 185-a may implement a parallel capacitor bank to progressively raise the voltage. In some examples, a first circuit set (e.g., subset of electronic components) may be associated with a first capacitor bank and a second circuit set may be associated with a second capacitor bank.

For example, a varactor bias voltage may be switched every 2 s with a settling time of 200 ns. By implementing multiple alternating circuit sets, the RIS 185-a may reduce the slew rate by a factor of 10 since the time to ramp up, ramp down, or set the voltage via an alternate circuit is 2 s instead of 200 ns. Additionally, or alternatively, power consumption may be drastically reduced since op-amps with a much lower quiescent current may be used. In some examples, switches may operate in pairs so that when a first tank capacitor is providing reverse bias to a varactor diode (e.g., a forwarding element 230), a second tank capacitor is being charged, and vice versa.

The timing information in the capability message from the RIS 185-a (e.g., the RIS controller 220) to the network node 105-a (e.g., via the control link 235-a) may include one or more timing parameters. For example, the capability message may include a first timing parameter T_{ws} that specifies the time for bringing the RIS array 225 up from a deep-sleep state (e.g., a power-saving mode). That is, the RIS-MT and the RIS array 225 may be distinct entities of the RIS 185-a, and the RIS control board may have a separate sleep process from the RIS-MT (e.g., powering-OFF one or more op-amps and DACs in the RIS control board of the proposed architecture for deep sleep and powering back ON). The first timing parameter T_{ws} may indicate the time from when a control signal (e.g., a downlink control information (DCI) message, the one or more control messages, a control message via the control link 235-b) is received by the RIS-MT (e.g., while the RIS array 225 is in a deep-sleep state) to the first symbol when the indicated pattern in the control signal can be applied onto the RIS array 225. For example, with reference to FIG. 4, the RIS 185-a may receive, in a symbol n (e.g., the first symbol 410-a) and while the RIS array 225 is in the deep-sleep mode, a DCI message indicating a RIS pattern (e.g., at a RIS-MT). Then, in or after a symbol n+T_{ws} (e.g., the second symbol 410-b), the RIS 185-a may apply the RIS pattern indicated by the DCI message. In some examples, the first timing parameter T_{ws} may include the time for the RIS-MT to decode the control signal. In some examples, the first timing parameter T_{ws} may be indicated or reported in a table with a quantity of slots or symbols versus subcarrier spacing (SCS). That is, the one or more timing parameters may be based on an SCS. Additionally, or alternatively, the first timing parameter T_{ws} may be indicated as a time duration (e.g., a quantity of microseconds or a quantity of nanoseconds).

In some cases, the RIS array 225 may revert to a default pattern when the RIS array 225 is not assisting a TRP or a UE 115. For example, the default pattern may be a soft-off (e.g., randomized) pattern, or the default pattern may be to retain a most recently applied pattern. In some examples, the one or more timing parameters in the capability message may include a second timing parameter T_{wd}, where T_{wd}≤T_{ws}. The second timing parameter T_{wd} may specify the time for reconfiguration of the RIS array 225 from the default state or default pattern (e.g., cold start). The second timing parameter T_{wd} may include the time from when the control signal (e.g., the DCI, the one or more control messages via the control link 235-b) is received by the RIS-MT (e.g., while a default pattern in applied on the RIS array 225) to the first symbol in which the RIS pattern indicated by the control signal can be applied onto the RIS array 225. For example, with reference to FIG. 4, the RIS 185-a may receive, in a symbol n (e.g., the first symbol 410-a) and while the RIS array 225 is in the default state (e.g., default pattern, default configuration), a DCI message indicating a RIS pattern (e.g., at a RIS-MT). Then, in or after a symbol n+T_{wd} (e.g., the second symbol 410-b), the RIS 185-a may apply the RIS pattern indicated by the DCI message. In some examples, the second timing parameter T_{wd} may include the time for the RIS-MT to decode the control signal. In some examples, the second timing parameter T_{wd} may be indicated or reported in a table with a quantity of slots or symbols versus SCS. Additionally, or alternatively, the second timing parameter T_{wd} may be indicated as a time duration (e.g., a quantity of microseconds or a quantity of nanoseconds).

In some cases, the RIS array 225 may be configured to apply multiple RIS patterns within a burst (e.g., a burst of 40 symbols) during which the RIS 185-a will assist one or more TRPs or UEs 115. For example, a DCI may convey, to the RIS-MT via the control link 235-b, multiple patterns and the durations in the burst for which the patterns will each be applied. In some examples, the one or more timing parameters in the capability message may include a third timing parameter T_{b}, where T_{b}≤T_{wd}. The third timing parameter T_{b} may specify the time for reconfiguration of the RIS array 225 within a burst (e.g., hot start). The third timing parameter T_{b} may indicate the time to switch the RIS array 225 from a current pattern (e.g., switch the forwarding elements 230 from a current voltage or a current direction 210) that is already known to the RIS controller 220. For example, with reference to FIG. 4, the RIS 185-a may receive, in a symbol n (e.g., the first symbol 410-a) and while the RIS array 225 is in a burst, a DCI message indicating a RIS pattern (e.g., at a RIS-MT). Then, in or after a symbol n+T_{b} (e.g., the second symbol 410-b), the RIS 185-a may apply the RIS pattern indicated by the DCI message. In some examples, the third timing parameter T_{b} may be indicated or reported in a table with a quantity of slots or symbols versus SCS. As an example, a symbol duration assumed to design circuits may be denoted by

$${T}_{Sym}^{Tar} .$$

For any SCS for which the operating symbol duration T_{Sym} satisfies

$${T}_{Sym} \geq {T}_{Sym}^{Tar} ,$$

the operating symbol duration T_{Sym} may be sufficient to prepare an alternate circuit for the next (e.g., an upcoming) RIS pattern. For any SCS for which the operating symbol duration T_{sym} satisfies

$${T}_{sym} < {T}_{Sym}^{Tar} ,$$

the operating symbol duration T_{Sym} may be insufficient to prepare an alternate circuit for the next (e.g., an upcoming) RIS pattern. In some examples, the third parameter T_{b} may be indicated as a quantity of symbols (e.g., or slots), such as

$${T}_{b} = ⌈ \frac{{T}_{Sym}^{Tar}}{{T}_{Sym}} ⌉$$

symbols. Additionally, or alternatively, the third parameter T_{b} may be reported as a time duration (e.g., a quantity of a quantity of microseconds or a quantity of nanoseconds) for preparing an alternate circuit for the next (e.g., an upcoming) RIS pattern (e.g., including settling time upon switching).

In some examples, the RIS 185-a may transmit, to the network node 105-a via the control link 235-a, an operating state message indicating a current operating state of the RIS array 225. The current operating state may be one of a set of multiple operating states that may include, for example, a deep sleep state associated with the first timing parameter T_{ws}, a default state associated with the second timing parameter T_{wd}, a hot state or burst state associated with the third timing parameter T_{b}, another state associated with another timing parameter, or a combination thereof. The one or more timing parameters may indicate a quantity of slots, a quantity of symbols, or a time duration for the RIS 185-a to switch one or more forwarding elements 230 of the RIS array 225 from forwarding in the first direction 210-b to forwarding in the second direction 210-c while the RIS array 225 is in the current operating state. Based on the capability message including an indication of one or more timing parameters and the operating state message indicating the current operating state of the RIS array 225, the network node 105-a may transmit one or more control messages instructing the RIS 185-a to forward the incident signal energy 205-a in the first direction 210-b during a first symbol period and to forward the incident signal energy 205-a in the second direction 210-c during a second symbol period. The network node 105-a may ensure that the one or more control messages do not violate the timing parameter associated with the current operating state of the RIS 185-a, as described in more detail with reference to FIG. 4.

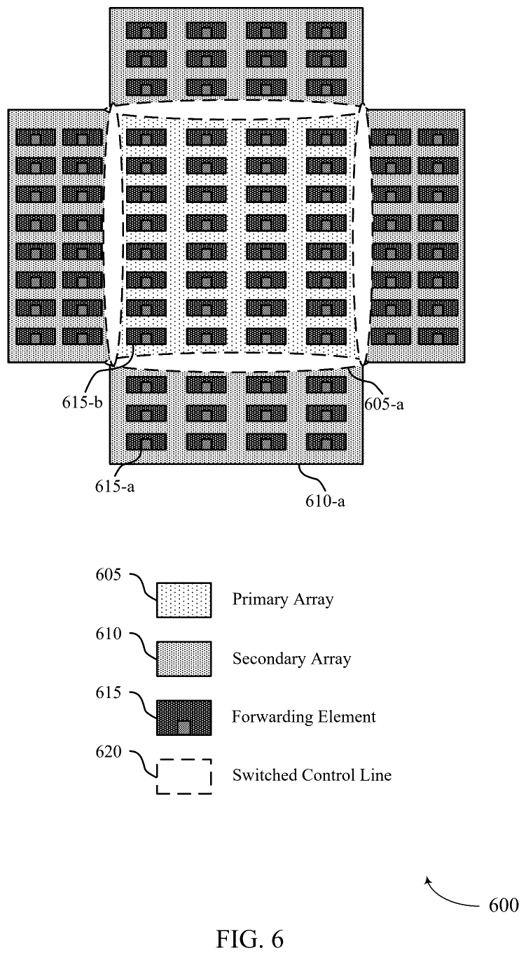

In some implementations, the boundary of the RIS array 225 may be extended, as illustrated and described in more detail with reference to FIG. 6. For example, the RIS array 225 may include a primary array (e.g., a main array) including a first subset of forwarding elements 230 and a secondary array (e.g., an extension array) including a second subset of forwarding elements 230. One or more forwarding elements 230 on the primary array (e.g., main RIS elements) may be independently driven. That is, constituent varactor diodes of the main array may be individually reverse-biased using any one of M power rails. One or more forwarding elements 230 on the second array (e.g., RIS extension elements) may be controlled in one or more of at least two options.

In a first option, one or more forwarding elements of the secondary array may have their respective control attached to and controlled by the nearest main RIS element or a main RIS element on the edge of the main array. That is, the second subset of forwarding elements 230 on the secondary array may be associated with a voltage source based on one of the elements in the first subset of forwarding elements 230 on the primary array being associated with the first voltage source. For instance, the power rail chosen for a main RIS element at the edge of the primary array may also be used to reverse bias one or more extension element varactor diodes in parallel.

In a second option, elements on the extension array may have their respective control that can be switched between a high attenuation state or be controlled by some main RIS element on the edge of the primary array. That is, the RIS 185-a may switch one or more secondary varactor diodes associated with the second subset of forwarding elements 230 from a first reverse bias to a second reverse bias based on a reverse bias of one or more primary varactor diodes associated with the first subset of forwarding elements 230, where the first reverse bias uses a voltage that causes the forwarding elements 230 to absorb a larger fraction of incident signal energy than the second reverse bias. Additionally, or alternatively, the RIS 185-a may switch one or more secondary varactor diodes associated with the second subset of forwarding elements from a first reverse bias based on a reverse bias of one or more primary varactor diodes associated with the first subset of forwarding elements to a second reverse bias, where the second reverse bias uses a voltage that causes the forwarding elements 230 to absorb a larger fraction of incident signal energy than the first reverse bias. For instance, via a common switch, either all varactor diodes of extension elements can be reverse biased using the highest voltage or the varactor diodes of the extension elements can be biased as in the first option.

FIG. 3 shows an example of a forwarding element diagram 300 that supports scalable design of reconfigurable intelligent surfaces in accordance with one or more aspects of the present disclosure. The forwarding element diagram 300 may implement or be implemented by one or more aspects of the wireless communications system 100 and the wireless communications system 200 described with reference to FIGS. 1 and 2, respectively. For example, the forwarding element diagram 300 may be implemented by a network node 105 and a RIS 185 (e.g., a RIS controller 220, a RIS array 225, or both) as described with reference to FIGS. 1 and 2 to support varactor-based forwarding at large scales.

For example, the resource diagram 300 may be utilized during efficient (e.g., flexible) alphabet selection at a RIS 185. For example, the RIS 185-a may include a quantity M of power rails 305 that each provide, for a varactor diode, a particular DC voltage, with the choice of voltages biasing all the varactor diodes being associated with a direction in which the RIS 185 may forward incident signal energy. Each power rail 305 may include at least one DAC 310 output (e.g., with B bits) amplified by an op-amp 315. The DACs 310, the op-amps 315, a MUX 320, and one or more other components may be housed in a control board of the RIS 185. A RIS 185 configured with an M-ary alphabet may include M power rails 305 per forwarding element, with M respective B-bit DAC 310 outputs. For example, a first power rail 305-a may use a first B-bit (e.g., 8 bit) DAC 310-a and a first op-amp 315-a to provide a first voltage that the MUX 320 may select as the output voltage. A second power rail 305-b may use a second B-bit (e.g., 8 bit) DAC 310-b and a second op-amp 315-b to provide a second voltage that the MUX 320 may select as the output voltage. An Mth (e.g., eighth, if M=8) power rail 305-c may use an Mth B-bit (e.g., 8 bit) DAC 310-c and an Mth op-amp 315-c to provide an Mth voltage that the MUX 320 may select as the output voltage. For example, in an 8-ary alphabet, the Mth power rail 305-c may be the eighth power rail 305 connected to the MUX 320, and the MUX 320 may select one of the eight voltages as the output voltage to reverse bias one or more varactor diodes.

A varactor may be a diode that can be tuned by applying a biasing voltage that changes a capacitance of the varactor and influences the electromagnetic characteristics of an associated forwarding element (e.g., a reflecting element or a refracting element). By changing the voltages applied across the varactor diodes of the RIS array, the RIS 185 may reflect, refract, or otherwise forward the incident signal energy in a particular direction or reflect the wavefront in a particular way. That is, the target direction or wavefront for the reflected signal energy may be translated or mapped to a set of input voltages to be applied on the varactor diodes associated with the forwarding elements on the RIS array. For example, each of the N forwarding elements (e.g., N varactor diodes across both polarizations) may be reverse biased by selecting (e.g., independently assigned to) one of M voltages associated with a respective power rail 305 output via a MUX 320 (e.g., with a total of N MUXes 320). In some examples, additional (e.g., up to N) op-amps 315 may be used, especially when individual forwarding elements (e.g., varactors) are connected via cables. Limiting the set of voltages to a relatively small and fixed alphabet may limit the directions or kinds of reflected wavefront shaping that are possible.

In some implementations, the RIS 185 or the network node 105 may select a set of voltages (e.g., an M-ary alphabet) based on current operating conditions. For example, the network node 105 may transmit, to the RIS 185, one or more control messages indicating the value of M, or indicating the sets of distinct voltages that are each associated with a forwarding direction (e.g., the set of voltages shown in Table 1 can be associated with one or more directions and a different set may be used for one or more other directions). The network node 105, the RIS 185, or both may change the set of biasing voltages depending on the kind of reflection to be achieved. For example, by giving a different digital input to a DAC 310, a different analog value may be output, which may be amplified by an op-amp 315 and (if selected from the M power rails by the MUX 320) may be used to reverse bias one or more varactor diodes to change the reflected signal energy 205-b or phase. Each forwarding element may be switched to select from one of the M power rails 305 (e.g., the first power rail 305-a associated with the first voltage or the second power rail 305-b associated with the second voltage). The set of M power rails 305 (e.g., M reverse biasing voltages) may be changed dynamically by changing the DAC 310 inputs, which may be done by the RIS 185 in real time, e.g., in response to control signaling from the network node 105.

FIG. 4 shows an example of a timing diagram 400 that supports scalable design of reconfigurable intelligent surfaces in accordance with one or more aspects of the present disclosure. The timing diagram 400 may implement or be implemented by one or more aspects of the wireless communications system 100 and the wireless communications system 200 described with reference to FIGS. 1 and 2, respectively. For example, the timing diagram 400 may be implemented by a network node 105 and a RIS 185 (e.g., a RIS controller 220, a RIS array 225, or both) as described with reference to FIGS. 1 and 2 to support varactor-based forwarding at large scales.

In some implementations, a power-efficient varactor-based RIS 185 may achieve a threshold settling time via pre-fetching and circuit-set switching. For example, the RIS 185 may implement two or more circuit sets 405 for applying a RIS pattern. A circuit set (e.g., including one or more circuits) may include a subset of electronic components (e.g., a subset of forwarding elements, a subset of DACs, a subset of op-amps, a subset of voltage sources, a subset of capacitors, a subset of other electronic components, or a combination thereof). Each circuit or circuit set 405 may be designed for a target OFDM symbol duration,

$${T}_{Sym}^{Tar} .$$

At least a first circuit set 405-a may be used to apply a current RIS pattern in a current OFDM symbol (e.g., the first symbol 410-a) while at least a second circuit set 405-b may be used to prepare an updated RIS pattern to be used in a following symbol (e.g., the second symbol 410-b), where an update of RIS pattern is configured (e.g., required, signaled). In some examples, the first circuit set 405-a and the second circuit set 405-b may both feed to the same set of varactor diodes and forwarding elements. Each circuit set 405 may realize separate biasing voltage sources and include distinct op-amps, tank capacitors, and other electronic components. The first symbol 410-a and the second symbol 410-b may be adjacent symbols, or the second symbol 410-b may be one or more symbols after the first symbol 410-a. That is, the first symbol 410-a may occur at symbol n and the second symbol 410-b may occur at symbol n+m, where m≥1.

In some examples, the network node 105 may transmit, to the RIS 185, one or more control messages indicating that the RIS 185 is to use circuit set switching. Based on circuit set switching being enabled by the one or more control messages, the RIS controller may realize a first forwarding (e.g., a first reflection) using the first circuit set 405-a during the first symbol 410-a (e.g., while the second circuit set 405-b is preparing source voltages for a second reflection). Then, the RIS controller may realize the second forwarding (e.g., the second reflection) using the second circuit set 405-b during the second symbol 410-b. Two or more circuit sets working in tandem may realize the varactor-based RIS 185.

For example, the RIS 185 (e.g., the RIS controller) may transmit, to the network node 105 and via a control link, a capability message indicating timing information (e.g., one or more timing parameters) associated with a duration for the RIS 185 to switch a circuit set of forwarding elements from forwarding in a first direction to forwarding in a second direction. Based on the timing information, the network node 105 may transmit, to the RIS controller via the control link, one or more control messages indicating a RIS pattern to be used one or more symbols 410 in advance. For example, the one or more control messages may instruct the RIS 185 to forward signal energy in a first direction during the first symbol 410-a and to forward signal energy in a second direction during the second symbol 410-b. During the first symbol 410-a, while the first circuit set 405-a is forwarding signal energy in the first direction, the second circuit set 405-b (a circuit set unused for forwarding signal energy during the first symbol 410-a) may be preparing the indicated RIS pattern for the second symbol 410-b. That is, the RIS 185 may prepare an indicated RIS pattern within one symbol interval, using a circuit set 405 that is not being used for applying the pattern in the current symbol 410. Then (e.g., at a time at or between the first symbol 410-a and the second symbol 410-b, or the symbol indicated by the one or more control messages), the RIS 185 may switch to using the second circuit set 405-b with the prepared RIS pattern. During the second symbol 410-b (e.g., while the second circuit set 405-b is forwarding the incoming signal energy in the second direction), the first circuit set 405-a may prepare the next updated RIS pattern for a third symbol 410 after the second symbol 410-b. The two or more circuit sets 405 may alternate between preparing a RIS pattern and forwarding signal energy in accordance with the prepared RIS pattern to drastically reduce a slew rate requirement on one or more op-amps by a large factor (e.g., a factor of 40 for an 8.9 us settling time instead of a 200 ns settling time). The cost trade-off for such circuit set switching is that an additional circuit set may be implemented.

In some examples, the RIS 185 may indicate, to the network node 105, one or more timing parameters, as described in more detail with reference to FIG. 2. Each of the one or more timing parameters may indicate the time for the RIS 185 to switch from a respective operating state to an indicated RIS pattern (e.g., a RIS pattern indicated in one or more control messages, such as a DCI). For example, the one or more timing parameters may include a first timing parameter T_{ws} associated with the time to bring up the RIS array from a deep-sleep state. Additionally, or alternatively, the one or more timing parameters may include a second timing parameter T_{wd} associated with the time to reconfigure the RIS array from a default state (e.g., cold start). Additionally, or alternatively, the one or more timing parameters may include a third timing parameter T_{b} associated with the time to reconfigure the RIS array within a burst (e.g., hot start). The RIS may transmit, to the network node 105, an operating state message indicating a current operating state of the RIS array. Based on the indicated current operating state and one or more timing parameters associated with the current operating state, the network node 105-a may transmit, to the RIS 185, one or more control messages instructing the RIS 185 to forward signal energy in the first direction during the first symbol 410-a using the first circuit set 405-a and to forward signal energy in the second direction during the second symbol 410-b using the second circuit set 405-b. That is, the network node 105 may ensure that the one or more control messages do not violate the one or more timing parameters associated with the current operating state of the RIS 185.

For example, the RIS 185 may indicate that a current operating state is a deep-sleep state, associated with the first timing parameter T_{ws}. The network node 105 may ensure that the one or more control messages are received by the RIS 185 in symbol n (e.g., the first symbol 410-a) while the RIS 185 is in the deep-sleep state and that the RIS pattern indicated in the one or more control messages is applied at or after symbol n+T_{ws} (e.g., the second symbol 410-b). In a second example, the RIS 185 may indicate that a current operating state is a default state (e.g., a default configuration, a cold start), associated with the second timing parameter T_{wd}. The network node 105 may ensure that the one or more control messages are received by the RIS 185 in symbol n (e.g., the first symbol 410-a) while the RIS 185 is in the default state and that the RIS pattern indicated in the one or more control messages is applied at or after symbol n+T_{wd} (e.g., the second symbol 410-b). In a third example, the RIS 185 may indicate that a current operating state is a burst state (e.g., a hot start), associated with the third timing parameter T_{b}. The network node 105 may ensure that the one or more control messages are received by the RIS 185 in symbol n (e.g., the first symbol 410-a) while the RIS 185 is in the burst state and that the RIS pattern indicated in the one or more control messages is applied at or after symbol n+T_{b} (e.g., the second symbol 410-b).

FIG. 5 shows an example of a capacitor bank diagram 500 that supports scalable design of reconfigurable intelligent surfaces in accordance with one or more aspects of the present disclosure. The capacitor bank diagram 500 may implement or be implemented by one or more aspects of the wireless communications system 100 and the wireless communications system 200 described with reference to FIGS. 1 and 2, respectively. For example, the forwarding element diagram 300 may be implemented by a network node 105 and a RIS 185 (e.g., a RIS controller 220, a RIS array 225, or both) as described with reference to FIGS. 1 and 2 to support varactor-based forwarding at large scales.

In some implementations, the varactor-based RIS 185 may employ a capacitor bank 505 for power efficiency. For example, one or more forwarding elements (e.g., varactor diodes) on a RIS array of the RIS 185 may use a reverse biasing voltage as high in magnitude as 18 V (e.g., or higher than 18 V). A baseline proposed approach may rely on an op-amp to raise each DAC output voltage to the target 18 V. However, in some implementations, the RIS 185 may use the capacitor bank 505 (or multiple capacitor banks 505) including one or more charged tank capacitors (e.g., the first capacitor 510-a, the second capacitor 510-b, and the third capacitor 510-c) holding a set of voltages. For example, the first capacitor 510-a may be associated with (e.g., pre-prepared with) a first voltage, the second capacitor 510-b may be associated with a second voltage, and the third capacitor 510-c may be associated with a third voltage. For a RIS pattern update (e.g., the one or more control messages from the network node 105), the RIS 185 may switch (e.g., using the switching network 515 connected to the output of the capacitor bank 505) each forwarding element (e.g., each varactor diode) to the tank capacitor 510 with the correct reverse biasing voltage. Each varactor diode (e.g., forwarding element) may discharge its connected biasing capacitor 510 at a relatively slow rate. The slower-rate charging network may be enough to keep the capacitors 510 charged and hold the target voltages. The RIS 185 may implement a parallel capacitor bank 505 to progressively raise the voltage. In some examples, a first circuit set (e.g., subset of electronic components) may be associated with a first capacitor bank 505 and a second circuit set may be associated with a second capacitor bank 505.

In some examples, at a particular symbol, the RIS 185 may change the biasing voltage of a varactor diode (e.g., in response to one or more control messages from the network node 105) by having the switching network 515 point to a different output of a different charged capacitor 510. For example, a varactor diode may be reverse biased to a first voltage associated with the first capacitor 510-a during a first symbol. Then, in a second symbol, the switching network 515 may switch so that the varactor diode is reverse biased to a second voltage associated with the second capacitor 510-b. The second capacitor 510-b may have been pre-charged to act as a DC voltage source at the updated voltage for the varactor diode, enabling quicker voltage switching for the varactor diode (e.g., immediate switching). Because the varactor may draw the voltage down, the capacitor bank 505 may be maintained by a charging network.

In some examples, switches in the switching network 515 may operate in pairs so that when the first tank capacitor 510-a is providing reverse bias to a varactor diode (e.g., a forwarding element), the second tank capacitor 510-b (e.g., and the third tank capacitor 510-c) is being charged, and vice versa. For example, the first capacitor 510-a may be part of a first circuit set and the second capacitor 510-b may be part of a second circuit set, as described in more detail with reference to FIGS. 2 and 4. Thus, each capacitor 510 may have an entire symbol duration to prepare to provide a particular voltage as a biasing source.

FIG. 6 shows an example of an array diagram 600 that supports scalable design of reconfigurable intelligent surfaces in accordance with one or more aspects of the present disclosure. The array diagram 600 may implement or be implemented by one or more aspects of the wireless communications system 100 and the wireless communications system 200 described with reference to FIGS. 1 and 2, respectively. For example, the array diagram 600 may be implemented by a network node 105 and a RIS 185 (e.g., a RIS controller 220, a RIS array 225, or both) as described with reference to FIGS. 1 and 2 to support varactor-based forwarding at large scales.

In some implementations, the boundary of an array of the RIS 185 may be extended. For example, the RIS array may include a primary array 605 (e.g., a main array, such as the primary array 605-a) including a first subset of forwarding elements 615 and one or more secondary arrays 610 (e.g., the secondary array 610-a, an extension array) including a second subset of forwarding elements 615. One or more forwarding elements 615 on the primary array 605-a (e.g., main RIS elements, such as the primary forwarding element 615-b) may be independently driven. That is, constituent varactor diodes of the primary array 605-a may be individually reverse-biased using any one of M power rails. One or more forwarding elements 615 on the second array (e.g., RIS extension elements, such as the secondary forwarding element 615-a) may be controlled in one or more of at least two options.

In a first option, one or more forwarding elements 615 of the secondary array 610-a (e.g., the secondary forwarding element 615-a) may have their respective control controlled by the nearest main RIS element or a main RIS element on the edge of the main array (e.g., the primary forwarding element 615-b). That is, the second subset of forwarding elements 615 on the secondary array 610-a may be associated with a voltage source based on the first subset of forwarding elements 615 on the primary array 605-a being associated with the first voltage source. For instance, the power rail chosen for a main RIS element at the edge of the primary array 605-a (e.g., the primary forwarding element 615-b) may also be used to reverse bias one or more extension element varactor diodes in parallel (e.g., the secondary forwarding element 615-a may share a switched control line 620 with the primary forwarding element 615-b).

In a second option, elements on the secondary array 610-a (e.g., the secondary forwarding element 615-a) may have their respective control that can be switched between a high attenuation state or be controlled by some main RIS element on the edge of the primary array 605-a (e.g., the primary forwarding element 615-b). That is, the RIS 185 may switch one or more secondary varactor diodes (e.g., the secondary forwarding element 615-a) associated with the second subset of forwarding elements 615 from a first reverse bias to a second reverse bias based on a reverse bias of one or more primary varactor diodes (e.g., the primary forwarding element 615-b) associated with the first subset of forwarding elements 615, where the first reverse bias uses a voltage that causes the forwarding elements 615 to absorb a larger fraction of incident signal energy than the second reverse bias. Additionally, or alternatively, the RIS 185 may switch one or more secondary varactor diodes (e.g., the secondary forwarding element 615-a) associated with the second subset of forwarding elements 615 from a first reverse bias based on a reverse bias of one or more primary varactor diodes (e.g., the primary forwarding element 615-b) associated with the first subset of forwarding elements 615 to a second reverse bias, where the second reverse bias uses a voltage that causes the forwarding elements 615 to absorb a larger fraction of incident signal energy than the first reverse bias. For instance, via a common switch, either all varactor diodes of extension elements can be reverse biased using the highest voltage or the varactor diodes of the extension elements can be biased as in the first option.

By implementing the secondary arrays 610, the RIS 185 may increase the RIS array size, therefore making the RIS 185 capable of capturing more incident energy and reflecting or forwarding the signal energy in a target direction while limiting costs associated with control line complexity.

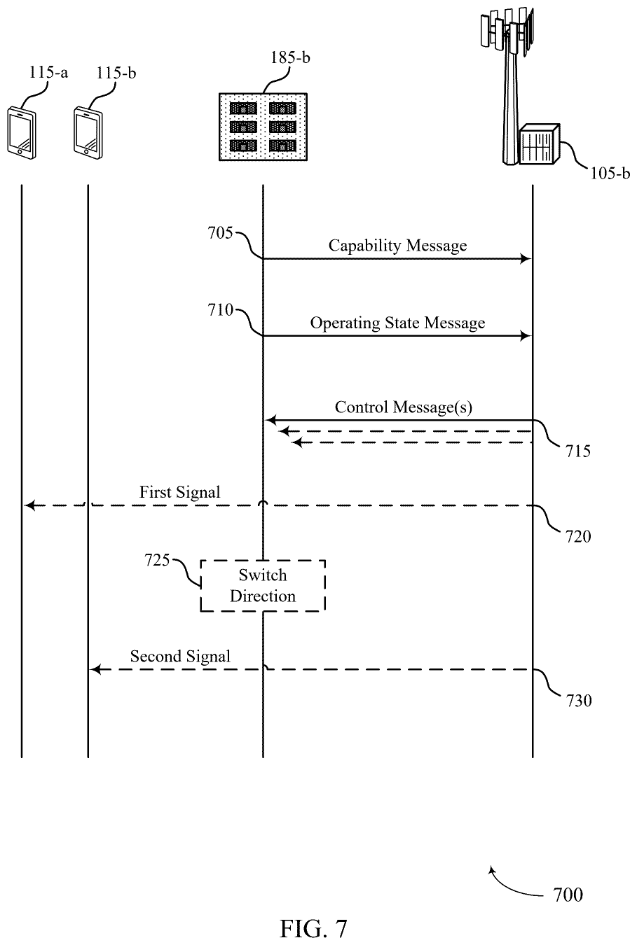

FIG. 7 shows an example of a process flow 700 that supports scalable design of reconfigurable intelligent surfaces in accordance with one or more aspects of the present disclosure. In some examples, the process flow 700 may be implemented by, or may implement aspects of, the wireless communications systems 100 and 200, the forwarding element diagram 300, the timing diagram 400, the capacitor bank diagram 500, and the array diagram 600. For example, the process flow 700 includes a network node 105-b, a RIS 185-b (e.g., a forwarding device), a UE 115-a, and a UE 115-b, which may be examples of the corresponding devices described with reference to FIGS. 1 and 2. Following the process flow 700, the RIS 185-b may efficiently forward signal energy in programmable directions at a large scale (e.g., with a relatively large aperture or array size). Alternative examples of the following may be implemented, where some steps are performed in a different order than described or are not performed at all. In some cases, steps may include additional features not mentioned below, or further steps may be added. Although the RIS 185-b, the UE 115-a, the UE 115-b, and the network node 105-b are shown performing the operations of the process flow 700, some aspects of some operations may also be performed by one or more other wireless devices. For example, the RIS 185-b may be any reflecting device, refracting device, forwarding device, or a combination thereof. The RIS 185-b may include a set of multiple forwarding elements (e.g., reflecting elements, refracting elements), where the set of multiple forwarding elements includes a set of multiple varactor diodes.

At 705, the RIS 185-b (e.g., a forwarding device) may transmit, to the network node 105-b, a capability message. The capability message may indicate one or more timing parameters associated with a duration for the RIS 185-b to switch a set of multiple forwarding elements from forwarding in a first direction to forwarding in a second direction. The one or more timing parameters may include a first timing parameter that indicates a quantity of slots, a quantity of symbols, or a duration for the RIS 185-b to switch the set of multiple forwarding elements from forwarding in the first direction to forwarding in the second direction. In some examples, the quantity of slots or the quantity of symbols may be based on a sub-carrier spacing. In some examples, the first direction may be associated with the UE 115-a and the second direction may be associated with the UE 115-b, as illustrated by the process flow 700. In some other examples, the first direction and the second direction may be associated with a same UE 115 (e.g., a UE 115 that is moving from a first location to a second location), multiple UEs 115, or no UEs 115.

In some examples, each of the one or more timing parameters may be associated with a respective operating state of a set of multiple operating states. For example, the one or more timing parameters may include at least the first timing parameter T_{ws} associated with the time to bring the RIS 185-b up from a deep-sleep state, the second timing parameter T_{wd} associated with the time to reconfigure the RIS 185-b from a default state, and the third timing parameter T_{b} associated with the time to reconfigure the RIS 185-b within a burst or from a hot state, as described in more detail with reference to FIGS. 2 and 4. In some cases, the one or more timing parameters may include a first timing parameter that indicates a quantity of slots, a quantity of symbols, or a duration for the RIS 185-b to switch the set of multiple forwarding elements of the array from forwarding in the first direction to forwarding in the second direction while the array is in a current operating state (e.g., as indicated at 710 by an operating state message). In some examples, the quantity of slots or the quantity of symbols may be based on a sub-carrier spacing.

In some cases, the set of multiple forwarding elements may include a primary array (e.g., a main array) including a first subset of multiple forwarding elements and a secondary array (e.g., a boundary extension to the surface of the RIS 185-b) including a second subset of multiple forwarding elements. While the first subset of multiple forwarding elements of the primary array may be independently driven (e.g., constituent varactor diodes of the main array may be individually reverse-biased using any power rail of a set of power rails), there may be at least two options for the RIS 185-b to control the second subset of multiple forwarding elements of the secondary array. In a first option, the second subset of multiple forwarding elements of the secondary array may be associated with a first voltage source based on the first subset of multiple forwarding elements of the primary array being associated with the first voltage source. That is, forwarding elements on the boundary extension may have their respective control controlled by a nearest forwarding element on the primary array, or to another forwarding element on the edge of the primary array. In a second option, forwarding elements of the secondary array may have their respective control switched between a high attenuation state or controlled by (e.g., connected, associated) to one or more elements of the primary array. That is, the RIS 185-b may switch one or more secondary varactor diodes associated with the second subset of forwarding elements from a first reverse bias to a second reverse bias based on a reverse bias of one or more primary varactor diodes associated with the first subset of forwarding elements, where the first reverse bias uses a voltage that causes forwarding elements to absorb a larger fraction of incident signal energy than the second reverse bias. Additionally, or alternatively, the RIS 185-b may switch one or more secondary varactor diodes associated with the second subset of forwarding elements from a first reverse bias based on a reverse bias of one or more primary varactor diodes associated with the first subset of forwarding elements to a second reverse bias, where the second reverse bias uses a voltage that causes forwarding elements to absorb a larger fraction of incident signal energy than the first reverse bias.

At 710, the RIS 185-b may transmit, to the network node 105-b, an operating state message. The operating state message may indicate a current operating state of an array including the set of multiple forwarding elements of the RIS 185-b. For example, the operating state message may indicate that the current operating state is a deep-sleep state or power-saving state associated with the first timing parameter T_{ws}. Additionally, or alternatively, the operating state message may indicate that the current operating state is a default state or cold state associated with the second timing parameter T_{wd}. Additionally, or alternatively, the operating state message may indicate that the current operating state is a burst state or a hot state associated with the third timing parameter T_{b}.

At 715, the network node 105-b may output or transmit, and the RIS 185-b may receive based on the indicated one or more timing parameters, one or more control messages. The one or more control messages may instruct the RIS 185-b to forward signal energy in the first direction during a first symbol (e.g., forward a first signal to the first UE 115-a at 720) and to forward signal energy in the second direction during a second symbol period (e.g., forward a second signal to the second UE 115-b at 735). The first symbol period and the second symbol period may be different.

In some examples, the one or more control messages may be based on the operating state message at 710. For example, the RIS 185-b may indicate at 710 that a current operating state is a deep-sleep state, associated with the first timing parameter T_{ws}. The network node 105-b may ensure that the one or more control messages at 715 are received by the RIS 185-b in symbol n while the RIS 185-b is in the deep-sleep state and that the RIS pattern indicated in the one or more control messages is applied at or after symbol n+T_{ws}. In a second example, the RIS 185-b may indicate at 710 that a current operating state is a default state (e.g., a default configuration, a cold start), associated with the second timing parameter T_{wd}. The network node 105-b may ensure that the one or more control messages are received by the RIS 185-b in symbol n while the RIS 185-b is in the default state and that the RIS pattern indicated in the one or more control messages is applied at or after symbol n+T_{wd}. In a third example, the RIS 185-b may indicate at 710 that a current operating state is a burst state (e.g., a hot start), associated with the third timing parameter T_{b}. The network node 105-b may ensure that the one or more control messages are received by the RIS 185-b in symbol n while the RIS 185-b is in the burst state and that the RIS pattern indicated in the one or more control messages is applied at or after symbol n+T_{b}.

In some examples, the one or more control messages may indicate, based on the one or more timing parameters indicated by the capability message at 705, sets of distinct voltages that are each associated with a forwarding direction (e.g., the set of eight distinct voltages in Table 1 can be associated with one or more directions and a different set may be used for one or more other directions). For example, the one or more control messages may indicate a first voltage set associated with the first direction, a second voltage set associated with the second direction, one or more additional voltage sets associated with one or more additional directions, or a combination thereof. Additionally, or alternatively, the one or more control messages may indicate a total quantity of distinct voltages M in a set (e.g., an M-ary alphabet).

In some examples, the one or more control messages may indicate one or more subsets of electronic components (e.g., circuits) that the RIS 185-b is to use to forward signal energy. For example, the one or more control messages may indicate to forward signal energy in the first direction during the first symbol period using a first subset of electronic components and indicating to forward signal energy in the second direction during the second symbol period using a second subset of electronic components. The first subset of electronic components may be associated with a first capacitor bank and the second subset of electronic components may be associated with a second capacitor bank.

At 720, the network node 105-b may output signal energy (e.g., a first signal) to the RIS 185-b and the RIS 185-b may forward the incident signal energy in a first direction to the UE 115-a in accordance with the one or more control messages at 715. For example, the RIS 185-b may forward the first signal in a first symbol n using a first circuit set of electronic components. During this first symbol, a second circuit set at the RIS 185-b may be preparing a RIS pattern for use at 730.

At 725, the RIS 185-b may switch from forwarding signal energy in the first direction to forwarding signal energy in the second direction. For example, the RIS 185-b may switch from applying the first circuit set of electronic components at a first voltage to applying the second circuit set of electronic components at a pre-prepared second voltage, as described in more detail with reference to FIG. 4. For example, the RIS 185-b may switch from a first capacitor in a capacitor bank to a second capacitor in the capacitor bank, as described in more detail with reference to FIG. 5.

At 730, the network node 105-b may output signal energy (e.g., a second signal, which may be the same signal as the first signal) to the RIS 185-b and the RIS 185-b may forward the incident signal energy in a second direction to the UE 115-b in accordance with the one or more control messages at 715. For example, the RIS 185-b may forward the second signal in a second symbol n+m, where m≥1 using a second circuit set of electronic components. The RIS 185-a may not violate any of the timing information sent in the capability message at 705 or the operating state message at 710. For example, the RIS 185-b may indicate at 710 that a current operating state is a deep-sleep state, associated with the first timing parameter T_{ws}. The RIS 185-b may apply the RIS pattern indicated in the one or more control messages at or after symbol n+T_{ws}. In a second example, the RIS 185-b may indicate at 710 that a current operating state is a default state (e.g., a default configuration, a cold start), associated with the second timing parameter T_{wd}. The RIS 185-b may apply the RIS pattern indicated in the one or more control messages at or after symbol n+T_{wd}. In a third example, the RIS 185-b may indicate at 710 that a current operating state is a burst state (e.g., a hot start), associated with the third timing parameter T_{b}. The RIS 185-b may apply the RIS pattern indicated in the one or more control messages at or after symbol n+T_{b}.

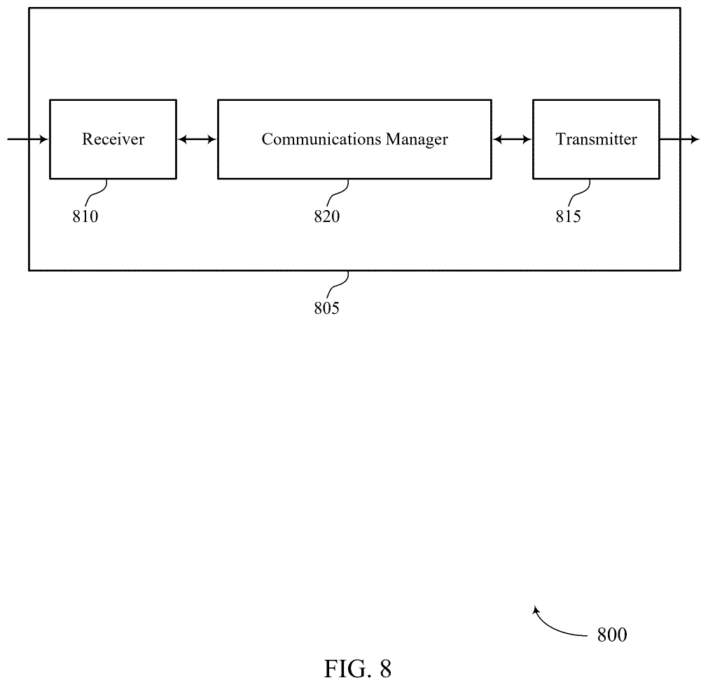

FIG. 8 shows a block diagram 800 of a device 805 that supports scalable design of reconfigurable intelligent surfaces in accordance with one or more aspects of the present disclosure. The device 805 may be an example of aspects of a UE 115 as described herein. The device 805 may include a receiver 810, a transmitter 815, and a communications manager 820. The device 805, or one or more components of the device 805 (e.g., the receiver 810, the transmitter 815, the communications manager 820), may include one or more processors, memory coupled with the one or more processors, and instructions stored in the memory that are executable by the one or more processors to enable the one or more processors to perform the scalable design of reconfigurable intelligent surfaces features discussed herein. Each of these components may be in communication with one another (e.g., via one or more buses).

The receiver 810 may provide a means for receiving information such as packets, user data, control information, or any combination thereof associated with various information channels (e.g., control channels, data channels, information channels related to scalable design of reconfigurable intelligent surfaces). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to scalable design of reconfigurable intelligent surfaces). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations or components thereof may be examples of means for performing various aspects of scalable design of reconfigurable intelligent surfaces as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for transmitting a capability message indicating one or more timing parameters associated with a time duration for the forwarding device to switch a set of multiple forwarding elements from forwarding in a first direction to forwarding in a second direction. The communications manager 820 is capable of, configured to, or operable to support a means for receiving, based on the indicated one or more timing parameters, one or more control messages that instructs the forwarding device to forward signal energy in the first direction during a first symbol period and to forward signal energy in the second direction during a second symbol period, where the first symbol period is different from the second symbol period.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for reduced power consumption and more efficient utilization of communication resources.

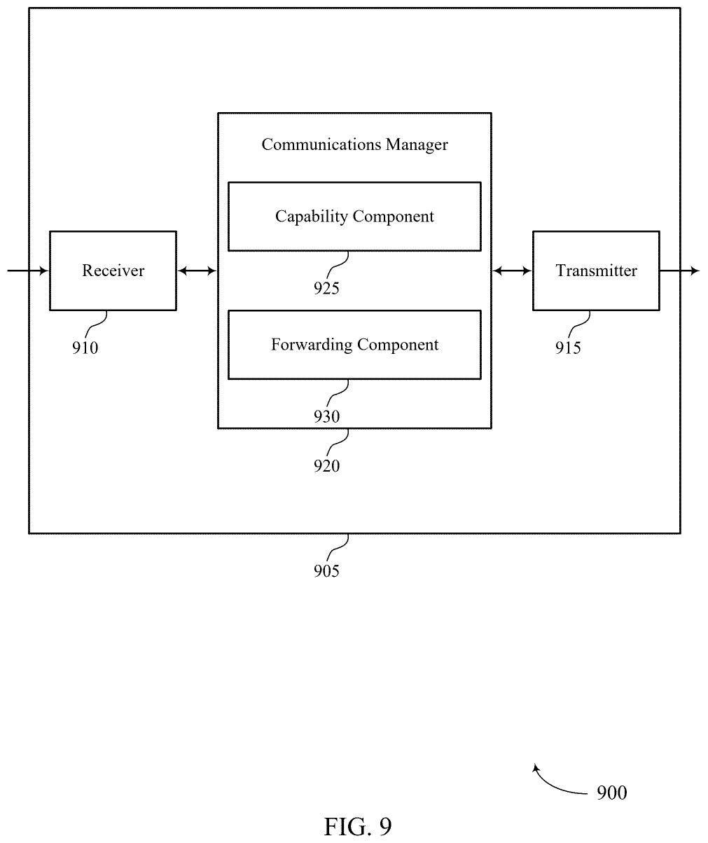

FIG. 9 shows a block diagram 900 of a device 905 that supports scalable design of reconfigurable intelligent surfaces in accordance with one or more aspects of the present disclosure. The device 905 may be an example of aspects of a device 805 or a UE 115 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for receiving information such as packets, user data, control information, or any combination thereof associated with various information channels (e.g., control channels, data channels, information channels related to scalable design of reconfigurable intelligent surfaces). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to scalable design of reconfigurable intelligent surfaces). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of scalable design of reconfigurable intelligent surfaces as described herein. For example, the communications manager 920 may include a capability component 925 a forwarding component 930, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The capability component 925 is capable of, configured to, or operable to support a means for transmitting a capability message indicating one or more timing parameters associated with a time duration for the forwarding device to switch a set of multiple forwarding elements from forwarding in a first direction to forwarding in a second direction. The forwarding component 930 is capable of, configured to, or operable to support a means for receiving, based on the indicated one or more timing parameters, one or more control messages that instructs the forwarding device to forward signal energy in the first direction during a first symbol period and to forward signal energy in the second direction during a second symbol period, where the first symbol period is different from the second symbol period.

In some cases, the capability component 925 and the forwarding component 930 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the capability component 925 and the forwarding component 930 discussed herein. A transceiver processor may be collocated with and/or communicate with (e.g., direct the operations of) a transceiver of the device. A radio processor may be collocated with and/or communicate with (e.g., direct the operations of) a radio (e.g., an NR radio, an LTE radio, a Wi-Fi radio) of the device. A transmitter processor may be collocated with and/or communicate with (e.g., direct the operations of) a transmitter of the device. A receiver processor may be collocated with and/or communicate with (e.g., direct the operations of) a receiver of the device.

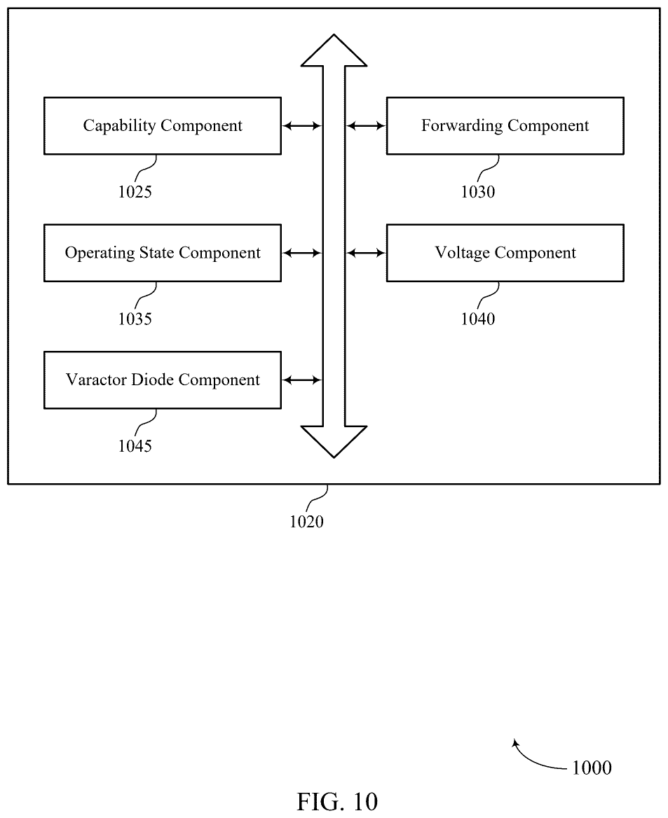

FIG. 10 shows a block diagram 1000 of a communications manager 1020 that supports scalable design of reconfigurable intelligent surfaces in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of scalable design of reconfigurable intelligent surfaces as described herein. For example, the communications manager 1020 may include a capability component 1025, a forwarding component 1030, an operating state component 1035, a voltage component 1040, a varactor diode component 1045, or any combination thereof. Each of these components, or components or subcomponents thereof (e.g., one or more processors, one or more memories), may communicate, directly or indirectly, with one another (e.g., via one or more buses).

The communications manager 1020 may support wireless communications in accordance with examples as disclosed herein. The capability component 1025 is capable of, configured to, or operable to support a means for transmitting a capability message indicating one or more timing parameters associated with a time duration for the forwarding device to switch a set of multiple forwarding elements from forwarding in a first direction to forwarding in a second direction. The forwarding component 1030 is capable of, configured to, or operable to support a means for receiving, based on the indicated one or more timing parameters, one or more control messages that instructs the forwarding device to forward signal energy in the first direction during a first symbol period and to forward signal energy in the second direction during a second symbol period, where the first symbol period is different from the second symbol period.

In some examples, the operating state component 1035 is capable of, configured to, or operable to support a means for transmitting an operating state message indicating a current operating state of an array including the set of multiple forwarding elements of the forwarding device, where the current operating state is one of a set of multiple operating states, and where the one or more control messages are based on the current operating state.

In some examples, the one or more timing parameters includes a first timing parameter that indicates a quantity of slots, a quantity of symbols, or a time duration for the forwarding device to switch the set of multiple forwarding elements of the array from forwarding in the first direction to forwarding in the second direction while the array is in the current operating state. In some examples, the quantity of slots or the quantity of symbols is based on a sub-carrier spacing.

In some examples, each of the one or more timing parameters is associated with a respective operating state of a set of multiple operating states.

In some examples, the one or more timing parameters includes a first timing parameter that indicates a quantity of slots, a quantity of symbols, or a time duration for the forwarding device to switch the set of multiple forwarding elements from forwarding in the first direction to forwarding in the second direction.

In some examples, to support receiving the one or more control messages, the voltage component 1040 is capable of, configured to, or operable to support a means for receiving, based on the indicated one or more timing parameters, an indication of sets of distinct voltages that are each associated with a forwarding direction.

In some examples, to support receiving the one or more control messages, the forwarding component 1030 is capable of, configured to, or operable to support a means for receiving the one or more control messages, indicating to forward signal energy in the first direction during the first symbol period using a first subset of electronic components and indicating to forward signal energy in the second direction during the second symbol period using a second subset of electronic components.

In some examples, the first subset of electronic components is associated with a first capacitor bank and the second subset of electronic components is associated with a second capacitor bank.

In some examples, to support receiving the one or more control messages, the forwarding component 1030 is capable of, configured to, or operable to support a means for receiving the one or more control messages. In some examples, to support receiving the one or more control messages, the forwarding component 1030 is capable of, configured to, or operable to support a means for forwarding, using a first subset of electronic components, signal energy in the first direction during the first symbol period indicated in the one or more control messages. In some examples, to support receiving the one or more control messages, the forwarding component 1030 is capable of, configured to, or operable to support a means for forwarding, using a second subset of electronic components, signal energy in the second direction during the second symbol period indicated in the control message.

In some examples, an array including the set of multiple forwarding elements includes a first set of multiple forwarding elements and a second set of multiple forwarding elements. In some examples, the first set of multiple forwarding elements is a primary array and the second set of multiple forwarding elements is a secondary array.

In some examples, the second set of multiple forwarding elements of the secondary array are associated with a first voltage source based on the one or more elements of the first set of multiple forwarding elements of the primary array being associated with the first voltage source.

In some examples, the varactor diode component 1045 is capable of, configured to, or operable to support a means for switching one or more secondary varactor diodes associated with the second set of multiple forwarding elements from a first reverse bias to a second reverse bias based on a reverse bias of one or more primary varactor diodes associated with the first set of multiple forwarding elements, where the first reverse bias uses a voltage that causes forwarding elements to absorb a larger fraction of incident signal energy than the second reverse bias.

In some examples, the varactor diode component 1045 is capable of, configured to, or operable to support a means for switching one or more secondary varactor diodes associated with the second set of multiple forwarding elements from a first reverse bias based on a reverse bias of one or more primary varactor diodes associated with the first set of multiple forwarding elements to a second reverse bias, where the second reverse bias uses a voltage that causes forwarding elements to absorb a larger fraction of incident signal energy than the first reverse bias.

In some examples, the forwarding device includes a reflecting device, a refracting device, or both.

In some examples, the set of multiple forwarding elements includes a set of multiple varactor diodes.

In some cases, the capability component 1025, the forwarding component 1030, the operating state component 1035, the voltage component 1040, and the varactor diode component 1045 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the capability component 1025, the forwarding component 1030, the operating state component 1035, the voltage component 1040, and the varactor diode component 1045 discussed herein.

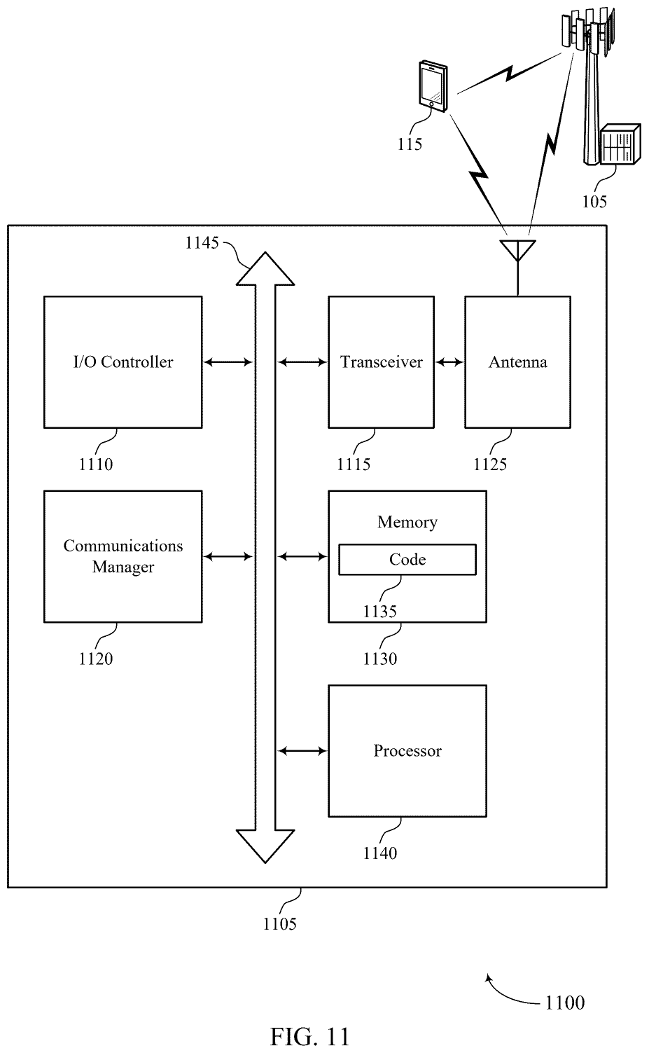

FIG. 11 shows a diagram of a system 1100 including a device 1105 that supports scalable design of reconfigurable intelligent surfaces in accordance with one or more aspects of the present disclosure. The device 1105 may be an example of or include components of a device 805, a device 905, or a UE 115 as described herein. The device 1105 may communicate (e.g., wirelessly) with one or more other devices (e.g., network nodes 105, UEs 115, or a combination thereof). The device 1105 may include components for bi-directional voice and data communications including components for transmitting and receiving communications, such as a communications manager 1120, an input/output (I/O) controller, such as an I/O controller 1110, a transceiver 1115, one or more antennas 1125, at least one memory 1130, code 1135, and at least one processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally, or alternatively, the I/O controller 1110 may represent or interact with a modem, a keyboard, a mouse, a touchscreen, or a similar device. In some cases, the I/O controller 1110 may be implemented as part of one or more processors, such as the at least one processor 1140. In some cases, a user may interact with the device 1105 via the I/O controller 1110 or via hardware components controlled by the I/O controller 1110.

In some cases, the device 1105 may include a single antenna. However, in some other cases, the device 1105 may have more than one antenna, which may be capable of concurrently transmitting or receiving multiple wireless transmissions. The transceiver 1115 may communicate bi-directionally via the one or more antennas 1125 using wired or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The at least one memory 1130 may include random access memory (RAM) and read-only memory (ROM). The at least one memory 1130 may store computer-readable, computer-executable, or processor-executable code, such as the code 1135. The code 1135 may include instructions that, when executed by the at least one processor 1140, cause the device 1105 to perform various functions described herein. The code 1135 may be stored in a non-transitory computer-readable medium such as system memory or another type of memory. In some cases, the code 1135 may not be directly executable by the at least one processor 1140 but may cause a computer (e.g., when compiled and executed) to perform functions described herein. In some cases, the at least one memory 1130 may include, among other things, a basic I/O system (BIOS) which may control basic hardware or software operation such as the interaction with peripheral components or devices.

The at least one processor 1140 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1140 may be configured to operate a memory array using a memory controller. In some other cases, a memory controller may be integrated into the at least one processor 1140. The at least one processor 1140 may be configured to execute computer-readable instructions stored in a memory (e.g., the at least one memory 1130) to cause the device 1105 to perform various functions (e.g., functions or tasks supporting scalable design of reconfigurable intelligent surfaces). For example, the device 1105 or a component of the device 1105 may include at least one processor 1140 and at least one memory 1130 coupled with or to the at least one processor 1140, the at least one processor 1140 and the at least one memory 1130 configured to perform various functions described herein.

In some examples, the at least one processor 1140 may include multiple processors and the at least one memory 1130 may include multiple memories. One or more of the multiple processors may be coupled with one or more of the multiple memories, which may, individually or collectively, be configured to perform various functions described herein. In some examples, the at least one processor 1140 may be a component of a processing system, which may refer to a system (such as a series) of machines, circuitry (including, for example, one or both of processor circuitry (which may include the at least one processor 1140) and memory circuitry (which may include the at least one memory 1130)), or components, that receives or obtains inputs and processes the inputs to produce, generate, or obtain a set of outputs. The processing system may be configured to perform one or more of the functions described herein. For example, the at least one processor 1140 or a processing system including the at least one processor 1140 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code 1135 (e.g., processor-executable code) stored in the at least one memory 1130 or otherwise, to perform one or more of the functions described herein.

The communications manager 1120 may support wireless communications in accordance with examples as disclosed herein. For example, the communications manager 1120 is capable of, configured to, or operable to support a means for transmitting a capability message indicating one or more timing parameters associated with a time duration for the forwarding device to switch a set of multiple forwarding elements from forwarding in a first direction to forwarding in a second direction. The communications manager 1120 is capable of, configured to, or operable to support a means for receiving, based on the indicated one or more timing parameters, one or more control messages that instructs the forwarding device to forward signal energy in the first direction during a first symbol period and to forward signal energy in the second direction during a second symbol period, where the first symbol period is different from the second symbol period.

By including or configuring the communications manager 1120 in accordance with examples as described herein, the device 1105 may support techniques for improved communication reliability, reduced power consumption, more efficient utilization of communication resources, improved coordination between devices, longer battery life, and improved utilization of processing capability.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the at least one processor 1140, the at least one memory 1130, the code 1135, or any combination thereof. For example, the code 1135 may include instructions executable by the at least one processor 1140 to cause the device 1105 to perform various aspects of scalable design of reconfigurable intelligent surfaces as described herein, or the at least one processor 1140 and the at least one memory 1130 may be otherwise configured to, individually or collectively, perform or support such operations.

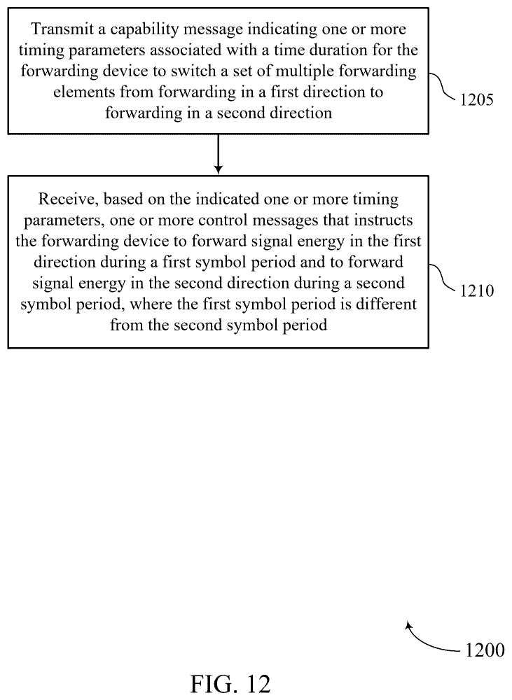

FIG. 12 shows a flowchart illustrating a method 1200 that supports scalable design of reconfigurable intelligent surfaces in accordance with one or more aspects of the present disclosure. The operations of the method 1200 may be implemented by a UE or its components as described herein. For example, the operations of the method 1200 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1205, the method may include transmitting a capability message indicating one or more timing parameters associated with a time duration for the forwarding device to switch a set of multiple forwarding elements from forwarding in a first direction to forwarding in a second direction. The operations of 1205 may be performed in accordance with examples as disclosed herein. In some examples, aspects of the operations of 1205 may be performed by a capability component 1025 as described with reference to FIG. 10.

At 1210, the method may include receiving, based on the indicated one or more timing parameters, one or more control messages that instructs the forwarding device to forward signal energy in the first direction during a first symbol period and to forward signal energy in the second direction during a second symbol period, where the first symbol period is different from the second symbol period. The operations of 1210 may be performed in accordance with examples as disclosed herein. In some examples, aspects of the operations of 1210 may be performed by a forwarding component 1030 as described with reference to FIG. 10.

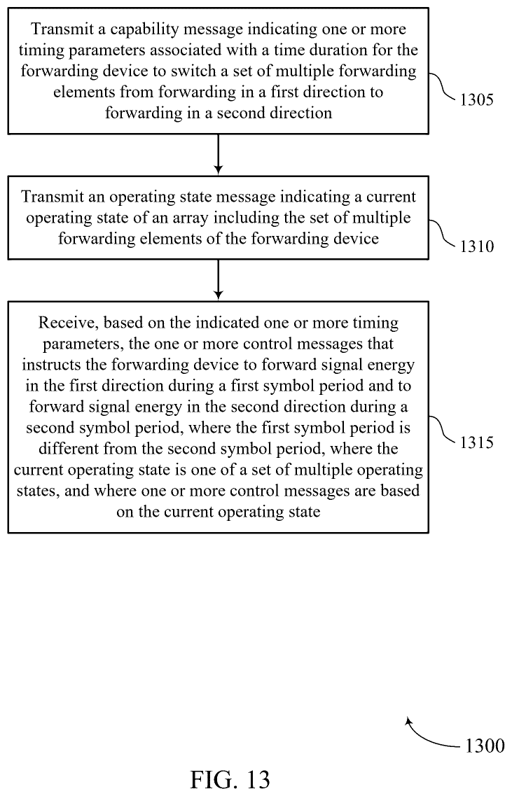

FIG. 13 shows a flowchart illustrating a method 1300 that supports scalable design of reconfigurable intelligent surfaces in accordance with one or more aspects of the present disclosure. The operations of the method 1300 may be implemented by a UE or its components as described herein. For example, the operations of the method 1300 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1305, the method may include transmitting a capability message indicating one or more timing parameters associated with a time duration for the forwarding device to switch a set of multiple forwarding elements from forwarding in a first direction to forwarding in a second direction. The operations of 1305 may be performed in accordance with examples as disclosed herein. In some examples, aspects of the operations of 1305 may be performed by a capability component 1025 as described with reference to FIG. 10.

At 1310, the method may include transmitting an operating state message indicating a current operating state of an array including the set of multiple forwarding elements of the forwarding device. The operations of 1310 may be performed in accordance with examples as disclosed herein. In some examples, aspects of the operations of 1310 may be performed by an operating state component 1035 as described with reference to FIG. 10.

At 1315, the method may include receiving, based on the indicated one or more timing parameters, one or more control messages that instructs the forwarding device to forward signal energy in the first direction during a first symbol period and to forward signal energy in the second direction during a second symbol period, where the first symbol period is different from the second symbol period, where the current operating state is one of a set of multiple operating states, and where the one or more control messages are based on the current operating state. The operations of 1315 may be performed in accordance with examples as disclosed herein. In some examples, aspects of the operations of 1315 may be performed by a forwarding component 1030 as described with reference to FIG. 10.

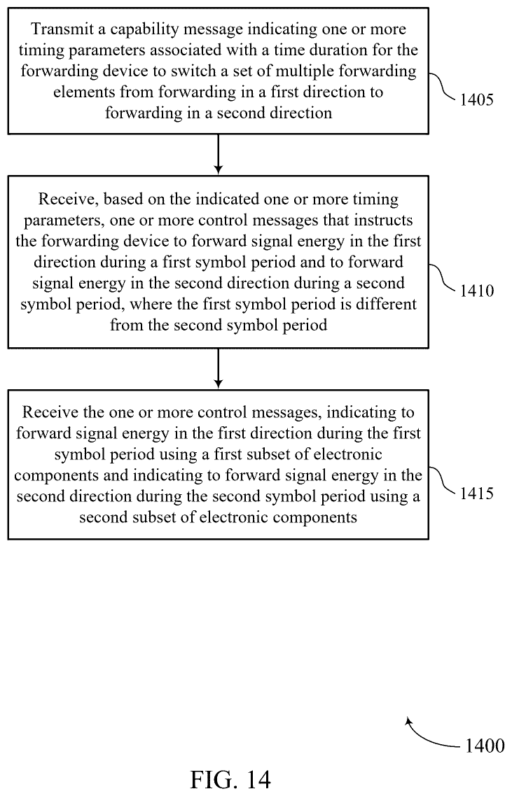

FIG. 14 shows a flowchart illustrating a method 1400 that supports scalable design of reconfigurable intelligent surfaces in accordance with one or more aspects of the present disclosure. The operations of the method 1400 may be implemented by a UE or its components as described herein. For example, the operations of the method 1400 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1405, the method may include transmitting a capability message indicating one or more timing parameters associated with a time duration for the forwarding device to switch a set of multiple forwarding elements from forwarding in a first direction to forwarding in a second direction. The operations of 1405 may be performed in accordance with examples as disclosed herein. In some examples, aspects of the operations of 1405 may be performed by a capability component 1025 as described with reference to FIG. 10.

At 1410, the method may include receiving, based on the indicated one or more timing parameters, one or more control messages that instructs the forwarding device to forward signal energy in the first direction during a first symbol period and to forward signal energy in the second direction during a second symbol period, where the first symbol period is different from the second symbol period. The operations of 1410 may be performed in accordance with examples as disclosed herein. In some examples, aspects of the operations of 1410 may be performed by a forwarding component 1030 as described with reference to FIG. 10.

At 1415, the method may include receiving the one or more control messages, indicating to forward signal energy in the first direction during the first symbol period using a first subset of electronic components and indicating to forward signal energy in the second direction during the second symbol period using a second subset of electronic components. The operations of 1415 may be performed in accordance with examples as disclosed herein. In some examples, aspects of the operations of 1415 may be performed by a forwarding component 1030 as described with reference to FIG. 10.

The following provides an overview of aspects of the present disclosure:

Aspect 1: A method for wireless communications at a forwarding device, comprising: transmitting a capability message indicating one or more timing parameters associated with a time duration for the forwarding device to switch a plurality of forwarding elements from forwarding in a first direction to forwarding in a second direction; and receiving, based at least in part on the indicated one or more timing parameters, one or more control messages that instructs the forwarding device to forward signal energy in the first direction during a first symbol period and to forward signal energy in the second direction during a second symbol period, wherein the first symbol period is different from the second symbol period.

Aspect 2: The method of aspect 1, further comprising: transmitting an operating state message indicating a current operating state of an array comprising the plurality of forwarding elements of the forwarding device, wherein the current operating state is one of a plurality of operating states, and wherein the one or more control messages are based at least in part on the current operating state.

Aspect 3: The method of aspect 2, wherein the one or more timing parameters includes a first timing parameter that indicates a quantity of slots, a quantity of symbols, or a time duration for the forwarding device to switch the plurality of forwarding elements of the array from forwarding in the first direction to forwarding in the second direction while the array is in the current operating state, and the quantity of slots or the quantity of symbols is based at least in part on a sub-carrier spacing.

Aspect 4: The method of any of aspects 1 through 3, wherein each of the one or more timing parameters is associated with a respective operating state of a plurality of operating states.

Aspect 5: The method of any of aspects 1 through 4, wherein the one or more timing parameters includes a first timing parameter that indicates a quantity of slots, a quantity of symbols, or a time duration for the forwarding device to switch the plurality of forwarding elements from forwarding in the first direction to forwarding in the second direction.

Aspect 6: The method of any of aspects 1 through 5, wherein receiving the one or more control messages further comprises: receiving, based at least in part on the indicated one or more timing parameters, an indication of a set of distinct voltages that are each associated with a forwarding direction.

Aspect 7: The method of any of aspects 1 through 6, wherein receiving the one or more control messages further comprises: receiving the one or more control messages, indicating to forward signal energy in the first direction during the first symbol period using a first subset of electronic components and indicating to forward signal energy in the second direction during the second symbol period using a second subset of electronic components.

Aspect 8: The method of aspect 7, wherein the first subset of electronic components is associated with a first capacitor bank and the second subset of electronic components is associated with a second capacitor bank.

Aspect 9: The method of any of aspects 1 through 8, wherein receiving the one or more control messages further comprises: receiving the one or more control messages; forwarding, using a first subset of electronic components, signal energy in the first direction during the first symbol period indicated in the one or more control messages; and forwarding, using a second subset of electronic components, signal energy in the second direction during the second symbol period indicated in the control message.

Aspect 10: The method of any of aspects 1 through 9, wherein an array comprising the plurality of forwarding elements comprises a first plurality of forwarding elements and a second plurality of forwarding elements, the first plurality of forwarding elements is a primary array and the second plurality of forwarding elements is a secondary array.

Aspect 11: The method of aspect 10, wherein the second plurality of forwarding elements of the secondary array are associated with a first voltage source based at least in part on the first plurality of forwarding elements of the primary array being associated with the first voltage source.

Aspect 12: The method of any of aspects 10 through 11, further comprising: switching one or more secondary varactor diodes associated with the second plurality of forwarding elements from a first reverse bias to a second reverse bias based at least in part on a reverse bias of one or more primary varactor diodes associated with the first plurality of forwarding elements, wherein the first reverse bias uses a voltage that causes forwarding elements to absorb a larger fraction of incident signal energy than the second reverse bias.

Aspect 13: The method of any of aspects 10 through 12, further comprising: switching one or more secondary varactor diodes associated with the second plurality of forwarding elements from a first reverse bias based at least in part on a reverse bias of one or more primary varactor diodes associated with the first plurality of forwarding elements to a second reverse bias, wherein the second reverse bias uses a voltage that causes forwarding elements to absorb a larger fraction of incident signal energy than the first reverse bias.

Aspect 14: The method of any of aspects 1 through 13, wherein the forwarding device comprises a reflecting device, a refracting device, or both.

Aspect 15: The method of any of aspects 1 through 14, wherein the plurality of forwarding elements comprises a plurality of varactor diodes.

Aspect 16: A forwarding device for wireless communications, comprising one or more memories storing processor-executable code, and one or more processors coupled with the one or more memories and individually or collectively operable to execute the code to cause the forwarding device to perform a method of any of aspects 1 through 15.

Aspect 17: A forwarding device for wireless communications, comprising at least one means for performing a method of any of aspects 1 through 15.

Aspect 18: A non-transitory computer-readable medium storing code for wireless communications, the code comprising instructions executable by one or more processors to perform a method of any of aspects 1 through 15.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A forwarding device, comprising:
one or more memories storing processor-executable code; and
one or more processors coupled with the one or more memories, wherein the one or more processors are individually or collectively operable to execute the code to cause the forwarding device to:
transmit a capability message indicating one or more timing parameters associated with a time duration for the forwarding device to switch a plurality of forwarding elements from forwarding in a first direction to forwarding in a second direction; and
receive, based at least in part on the indicated one or more timing parameters, one or more control messages that instructs the forwarding device to forward signal energy in the first direction during a first symbol period and to forward signal energy in the second direction during a second symbol period, wherein the first symbol period is different from the second symbol period.

2. The forwarding device of claim 1, wherein the one or more processors are individually or collectively further operable to cause the forwarding device to:
transmit an operating state message indicating a current operating state of an array comprising the plurality of forwarding elements of the forwarding device, wherein the current operating state is one of a plurality of operating states, and wherein the one or more control messages are based at least in part on the current operating state.

3. The forwarding device of claim 2, wherein the one or more timing parameters includes a first timing parameter that indicates a quantity of slots, a quantity of symbols, or a time duration for the forwarding device to switch the plurality of forwarding elements of the array from forwarding in the first direction to forwarding in the second direction while the array is in the current operating state, and wherein the quantity of slots or the quantity of symbols is based at least in part on a sub-carrier spacing.

4. The forwarding device of claim 1, wherein each of the one or more timing parameters is associated with a respective operating state of a plurality of operating states.

5. The forwarding device of claim 1, wherein the one or more timing parameters includes a first timing parameter that indicates a quantity of slots, a quantity of symbols, or a time duration for the forwarding device to switch the plurality of forwarding elements from forwarding in the first direction to forwarding in the second direction.

6. The forwarding device of claim 1, wherein the one or more processors are individually or collectively configured to cause the forwarding device to receive the one or more control messages by being individually or collectively configured to cause the forwarding device to:
receive, based at least in part on the indicated one or more timing parameters, an indication of sets of distinct voltages that are each associated with a forwarding direction.

7. The forwarding device of claim 1, wherein the one or more processors are individually or collectively configured to cause the forwarding device to receive the one or more control messages by being individually or collectively configured to cause the forwarding device to:
receive the one or more control messages, indicating to forward signal energy in the first direction during the first symbol period using a first subset of electronic components and indicating to forward signal energy in the second direction during the second symbol period using a second subset of electronic components.

8. The forwarding device of claim 7, wherein the first subset of electronic components is associated with a first capacitor bank and the second subset of electronic components is associated with a second capacitor bank.

9. The forwarding device of claim 1, wherein the one or more processors are individually or collectively configured to cause the forwarding device to receive the one or more control messages by being individually or collectively configured to cause the forwarding device to:
receive the one or more control messages;
forward, using a first subset of electronic components, signal energy in the first direction during the first symbol period indicated in the one or more control messages; and
forward, using a second subset of electronic components, signal energy in the second direction during the second symbol period indicated in the control message.

10. The forwarding device of claim 1, wherein an array comprising the plurality of forwarding elements comprises a first plurality of forwarding elements and a second plurality of forwarding elements, and wherein the first plurality of forwarding elements is a primary array and the second plurality of forwarding elements is a secondary array.

11. The forwarding device of claim 10, wherein the second plurality of forwarding elements of the secondary array are associated with a first voltage source based at least in part on the first plurality of forwarding elements of the primary array being associated with the first voltage source.

12. The forwarding device of claim 10, wherein the one or more processors are individually or collectively further configured to cause the forwarding device to:
switch one or more secondary varactor diodes associated with the second plurality of forwarding elements from a first reverse bias to a second reverse bias based at least in part on a reverse bias of one or more primary varactor diodes associated with the first plurality of forwarding elements, wherein the first reverse bias uses a voltage that causes forwarding elements to absorb a larger fraction of incident signal energy than the second reverse bias.

13. The forwarding device of claim 10, wherein the one or more processors are individually or collectively further configured to cause the forwarding device to:
switch one or more secondary varactor diodes associated with the second plurality of forwarding elements from a first reverse bias based at least in part on a reverse bias of one or more primary varactor diodes associated with the first plurality of forwarding elements to a second reverse bias, wherein the second reverse bias uses a voltage that causes forwarding elements to absorb a larger fraction of incident signal energy than the first reverse bias.

14. The forwarding device of claim 1, wherein the forwarding device comprises a reflecting device, a refracting device, or both.

15. The forwarding device of claim 1, wherein the plurality of forwarding elements comprises a plurality of varactor diodes.

16. A method for wireless communications at a forwarding device, comprising:
transmitting a capability message indicating one or more timing parameters associated with a time duration for the forwarding device to switch a plurality of forwarding elements from forwarding in a first direction to forwarding in a second direction; and
receiving, based at least in part on the indicated one or more timing parameters, one or more control messages that instructs the forwarding device to forward signal energy in the first direction during a first symbol period and to forward signal energy in the second direction during a second symbol period, wherein the first symbol period is different from the second symbol period.

17. The method of claim 16, further comprising:
transmitting an operating state message indicating a current operating state of an array comprising the plurality of forwarding elements of the forwarding device, wherein the current operating state is one of a plurality of operating states, and wherein the one or more control messages are based at least in part on the current operating state.

18. The method of claim 16, wherein receiving the one or more control messages further comprises:
receiving, based at least in part on the indicated one or more timing parameters, an indication of sets of distinct voltages that are each associated with a forwarding direction.

19. The method of claim 16, wherein receiving the one or more control messages further comprises:
receiving the one or more control messages, indicating to forward signal energy in the first direction during the first symbol period using a first subset of electronic components and indicating to forward signal energy in the second direction during the second symbol period using a second subset of electronic components.

20. The method of claim 16, wherein receiving the one or more control messages further comprises:
receiving the one or more control messages;
forwarding, using a first subset of electronic components, signal energy in the first direction during the first symbol period indicated in the one or more control messages; and
forwarding, using a second subset of electronic components, signal energy in the second direction during the second symbol period indicated in the control message.
